(19) United States
(12) Patent Application Publication
(10) Pub. No.: US 2020/0051193 A1
(43) Pub. Date: Feb. 13, 2020

(54) SYSTEMS AND METHODS FOR ALLOCATING ORDERS

(71) Applicant: BEIJING DIDI INFINITY TECHNOLOGY AND DEVELOPMENT CO., LTD., Beijing (CN)

(72) Inventors: Yingying MIAO, Beijing (CN); Zhilong WANG, Tianjin (CN); Shaohui SHI, Hangzhou (CN)

(73) Assignee: BEIJING DIDI INFINITY TECHNOLOGY AND DEVELOPMENT CO., LTD., Beijing (CN)

(21) Appl. No.: 16/234,286

(22) Filed: Dec. 27, 2018

Related U.S. Application Data
(63) Continuation of application No. PCT/CN2018/099587, filed on Aug. 9, 2018.

(51) Int. Cl. G06Q 50/26; G06Q 10/02; G06N 7/00

(52) U.S. Cl. CPC G06Q 50/265; G06N 7/005; G06Q 10/02

(57) ABSTRACT

Systems and methods for allocating orders are provided. A method includes extracting target order features of an order associated with a service requester; extracting target requester features of the service requester; extracting target provider features of a service provider; obtaining a prediction model for determining a probability that the target incident occurs; and determining the occurrence probability of the target incident using the prediction model based on the target order features, the target requester features, and the target provider features.

### CROSS-REFERENCE TO RELATED APPLICATIONS

This application is a continuation of International Application No. PCT/CN2018/099587, filed on Aug. 9, 2018, the entire contents of which are incorporated herein by reference.

### TECHNICAL FIELD

The present disclosure generally relates to systems and methods for using artificial intelligence to process taxi hailing orders of online to offline services, and in particular, to systems and methods for allocating orders based on an occurrence probability of a target incident.

### BACKGROUND

Online to offline services, such as online taxi hailing services, utilizing Internet technology have become increasingly popular because of their convenience. However, when a passenger requests a taxi hailing service through an online to offline service platform, the online to offline service platform may assign a driver to serve the passenger without considering the possibility of an incident (e.g., a vicious incident), thereby affecting the service quality and/or experience for the passenger and/or the driver. Therefore, it is desirable to provide suitable systems and methods for allocating orders.

### SUMMARY

In one aspect of the present disclosure, a system of one or more electronic devices for determining a target incident occurrence probability is provided. The system may comprise at least one storage device and at least one processor in communication with the at least one storage device. The at least one storage device may include an operation system and a first set of instructions compatible with the operation system for determining an occurrence probability of a target incident. When executing the operation system and the set of instructions, the at least one processor may be directed to extract target order features of an order associated with a service requester; extract target requester features of the service requester; extract target provider features of a service provider; obtain a prediction model for determining a probability that the target incident occurs; and determine the occurrence probability of the target incident using the prediction model based on the target order features, the target requester features, and the target provider features.

In some embodiments, to obtain the prediction model, the at least one processor may be further directed to obtain training data. The training data may include a plurality of positive samples in each of which the target incident has not occurred and a plurality of negative samples in each of which the target incident has occurred. Each of the plurality of positive samples and the plurality of negative samples may include historical transaction data and historical incident data corresponding to the historical transaction data. The at least one processor may be further directed to extract a plurality of candidate features from the historical transaction data of the plurality of positive samples and the plurality of negative samples. For each of the plurality of positive samples and the plurality of negative samples, the at least one processor may be further directed to determine one or more target features from the plurality of candidate features using a feature selection algorithm. The at least one processor may be further directed to generate the prediction model based on the one or more target features of the plurality of positive samples, the one or more target features of the plurality of negative samples, and the historical incident data of the plurality of positive samples and the plurality of negative samples.

In some embodiments, to obtain the prediction model, the at least one processor may be further directed to determine that the training data includes an imbalanced sample composition based on the plurality of positive samples and the plurality of negative samples; and in response to a determination that the training data includes an imbalanced sample composition, balance the sample composition based on the training data using a sample balancing technique.

In some embodiments, the sample balancing technique may include under-sampling the plurality of positive samples.

In some embodiments, the sample balancing technique may include over-sampling the plurality of negative samples.

In some embodiments, to balance the sample composition, the at least one processor may be further directed to determine a plurality of synthetic samples using a K nearest neighbors (KNN) technique; and designate the plurality of synthetic samples as negative samples.

In some embodiments, to determine the plurality of synthetic samples using the KNN technique, the at least one processor may be directed to generate a feature vector based on the one or more target features of the negative sample for each of the plurality of negative samples. For each of the feature vectors, the at least one processor may further directed to determine a first number of nearest neighbors of the feature vector using the KNN technique; select a second number of nearest neighbors from the first number of nearest neighbors according to an over-sampling rate; and generate synthetic samples with respect to the feature vector based on the feature vector and the second number of nearest neighbors.

In some embodiments, the at least one storage device may further include a second set of instructions compatible with the operation system for allocating orders. When the at least one processor executes the second set of instructions, the at least one processor may be further directed to obtain one or more target orders from one or more requester terminals associated with one or more target service requesters; identify a plurality of candidate service providers available to accept the one or more orders; determine candidate requester-provider pairs by associating each of the one or more target service requesters with each of the plurality of candidate service providers; for each of the candidate requester-provider pairs, execute the first set of instructions to determine an occurrence probability that the target incident occurs; and allocate the one or more target orders based at least in part on the occurrence probabilities of the target incident and corresponding candidate requester-provider pairs.

In some embodiments, the prediction model may include an eXtreme Gradient Boosting (Xgboost) model.

In some embodiments, the target incident includes at least one of: assault, sexual harassment, killing, drunkenness, rape, or robbery.

In another aspect of the present disclosure, a method for determining an occurrence probability of a target incident is provided. The method may be implemented on one or more electronic devices having at least one storage device and at least one processor in communication with the at lest one storage device. The method may include extracting target order features of an order associated with a service requester; extracting target requester features of the service requester; extracting target provider features of a service provider; obtaining a prediction model for determining a probability that the target incident occurs; and determining the occurrence probability of the target incident using the prediction model based on the target order features, the target requester features, and the target provider features.

In some embodiments, the obtaining the prediction model may include obtaining training data, the training data including a plurality of positive samples in each of which the target incident has not occurred and a plurality of negative samples in each of which the target incident has occurred, each of the plurality of positive samples and the plurality of negative samples including historical transaction data and historical incident data corresponding to the historical transaction data; extracting a plurality of candidate features from the historical transaction data of the plurality of positive samples and the plurality of negative samples; for each of the plurality of positive samples and the plurality of negative samples, determining one or more target features from the plurality of candidate features using a feature selection algorithm; and generating the prediction model based on the one or more target features of the plurality of positive samples, the one or more target features of the plurality of negative samples, and the historical incident data of the plurality of positive samples and the plurality of negative samples.

In some embodiments, the obtaining the prediction model may further include determining that the training data includes an imbalanced sample composition based on the plurality of positive samples and the plurality of negative samples; and in response to a determination that the training data includes an imbalanced sample composition, balancing the sample composition based on the training data using a sample balancing technique.

In some embodiments, the balancing the sample composition may further include determining a plurality of synthetic samples using a K nearest neighbors (KNN) technique; and designating the plurality of synthetic samples as negative samples.

In some embodiments, the determining the plurality of synthetic samples using the KNN technique may include generating a feature vector based on the one or more target features of the negative sample for each of the plurality of negative samples. In some embodiments, for each of the feature vectors, the determining the plurality of synthetic samples using the KNN technique may further include determining a first number of nearest neighbors of the feature vector using the KNN technique; selecting a second number of nearest neighbors from the first number of nearest neighbors according to an over-sampling rate; and generating synthetic samples with respect to the feature vector based on the feature vector and the second number of nearest neighbors.

In some embodiments, the method may further include obtaining one or more target orders from one or more requester terminals associated with one or more target service requesters; identifying a plurality of candidate service providers available to accept the one or more orders; determining candidate requester-provider pairs by associating each of the one or more target service requesters with each of the plurality of candidate service providers; determining an occurrence probability that the target incident occurs for each of the candidate requester-provider pairs; and allocating the one or more target orders based at least in part on the occurrence probabilities of the target incident and corresponding candidate requester-provider pairs.

In another aspect of the present disclosure, a non-transitory computer readable medium is provided. The non-transitory computer readable medium may include an operation system and at least one set of instructions compatible with the operation system for determining an occurrence probability of a target incident. When executed by at least one processor of one or more electronic device, the at least one set of instructions directs the at least one processor to extract target order features of an order associated with a service requester; extract target requester features of the service requester; extract target provider features of a service provider; obtain a prediction model for determining a probability that the target incident occurs; and determine the occurrence probability of the target incident using the prediction model based on the target order features, the target requester features, and the target provider features.

In another aspect of the present disclosure, an artificial intelligent system of one or more electronic devices for determining an occurrence probability of a target incident is provided. The artificial intelligent system may include at least one first information exchange port corresponding to a service requesting system, wherein the service requesting system is associated with one or more requester terminals through wireless communications between the at least one first information exchange port and the one or more requester terminals. The artificial intelligent system may also include at least one second information exchange port corresponding to a service providing system, wherein the service providing system is associated with one or more provider terminals through wireless communications between the at least one second information exchange port and the one or more provider terminals. The artificial intelligent system may further include at least one storage device including an operation system and a first set of instructions compatible with the operation system for determining an occurrence probability of a target incident. The artificial intelligent system may further include at least one processor in communication with the at least one storage device, wherein when executing the operation system and the first set of instructions, the at least one processor may be further directed to extract target order features of the order; extract target requester features of the service requester associated with the order; identify a provider terminal associated with a service provider; extract target provider features of the service provider; obtain a prediction model for determining a probability that the target incident occurs; and determine the occurrence probability of the target incident using the prediction model based on the target order features, the target requester features, and the target provider features.

In another aspect of the present disclosure, a method for determining an occurrence probability of a target incident is provided. The method may be implemented on one or more electronic devices having at least one first information exchange port communicating with one or more requester terminals, at least one second information exchange port communicating with one or more provider terminals, at least one storage device, and at least one processor in communication with the at least one storage device. The method may include obtaining an order of a service requester from a requester terminal via the at least one first information exchange port; extracting target order features of the order; extracting target requester features of the service requester associated with the order; identifying a provider terminal associated with a service provider; extracting target provider features of the service provider; obtaining a prediction model for determining a probability that the target incident occurs; and determining the occurrence probability of the target incident using the prediction model based on the target order features, the target requester features, and the target provider features.

In another aspect of the present disclosure, a non-transitory computer readable medium is provided. The non-transitory computer readable medium may include an operation system and at least one set of instructions compatible with the operation system for determining an occurrence probability of a target incident. When executed by at least one processor of one or more electronic devices, the at least one set of instructions directs the at least one processor to obtain an order of a service requester from a requester terminal via at least one information exchange port; extract target order features of an order; extract target requester features of the service requester associated with the order; identify a provider terminal associated with a service provider; extract target provider features of the service provider; obtain a prediction model for determining a probability that the target incident occurs; and determine the occurrence probability of the target incident using the prediction model based on the target order features, the target requester features, and the target provider features.

In another aspect of the present disclosure, an artificial intelligent system for allocating orders is provided. The artificial intelligent system may include an incident prediction module and an order allocation module. The incident prediction module may be configured to determine occurrence probabilities of a target incident for orders. The order allocation module may be configured to allocation the orders based on the occurrence probabilities of the target incident.

In some embodiments, the incident prediction module may include an order feature extraction unit, a requester feature extraction unit, a provider feature extraction unit, a model determination unit, and an incident prediction unit. The order feature extraction unit may be configured to extract target order features of an order. The requester feature extraction unit may be configured to extract target requester features of a service requester associated with the order. The provider feature extraction unit may be configured to extract target provider features of a service provider. The model determination unit may be configured to obtain a prediction model for determining a probability that the target incident occurs. The incident prediction unit may be configured to determine the occurrence probability of the target incident using the prediction model based on the target order features, the target requester features, and the target provider features

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a block diagram of an exemplary artificial intelligent system according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating an exemplary mobile device according to some embodiments of the present disclosure;

FIG. 4A is a block diagram illustrating an exemplary processing device according to some embodiments of the present disclosure;

FIG. 4B is a block diagram illustrating an exemplary incident prediction module according to some embodiments of the present disclosure;

FIG. 4C is a block diagram illustrating an exemplary model determination unit according to some embodiments of the present disclosure;

FIG. 4D is a block diagram illustrating an exemplary order allocation module according to some embodiments of the present disclosure;

FIG. 5 is a flowchart illustrating an exemplary process for determining an occurrence probability that a target incident occurs using a prediction model according to some embodiments of the present disclosure;

FIG. 6 is a flowchart illustrating an exemplary process for generating a prediction model according to some embodiments of the present disclosure;

FIG. 7 is a flowchart illustrating an exemplary process for generating balanced samples according to some embodiments of the present disclosure;

FIG. 8A is a flowchart illustrating an exemplary process for generating synthetic samples according to some embodiments of the present disclosure;

FIG. 8B is a schematic diagram illustrating an imbalanced sample composition according to some embodiments of the present disclosure; and

FIG. 9 is a flowchart illustrating an exemplary process for allocating orders according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawing(s), all of which form part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order or simultaneously. Moreover, one or more other operations may be added to the flowcharts. One or more operations may be removed from the flowcharts.

Moreover, while the systems and methods disclosed in the present disclosure are described primarily regarding allocating orders of an online to offline service system, it should also be understood that this is only one exemplary embodiment. The system or method of the present disclosure may be applied to user of any other kind of online to offline service platform. For example, the system or method of the present disclosure may be applied to users in different transportation systems including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system that applies management and/or distribution, for example, a system for sending and/or receiving an express. The application scenarios of the system or method of the present disclosure may include a webpage, a plug-in of a browser, a client terminal, a custom system, an internal analysis system, an artificial intelligence robot, or the like, or any combination thereof.

The locations (e.g., a current location of a service requester, a current location of a service provider) in the present disclosure may be acquired by a positioning technology embedded in a wireless device (e.g., a requester terminal, a provider terminal, etc.). The positioning technology used in the present disclosure may include a global positioning system (GPS), a global navigation satellite system (GLONASS), a compass navigation system (COMPASS), a Galileo positioning system, a quasi-zenith satellite system (QZSS), a wireless fidelity (Wi-Fi) positioning technology, or the like, or any combination thereof. One or more of the above positioning technologies may be used interchangeably in the present disclosure. For example, the GPS-based method and the WiFi-based method may be used together as positioning technologies to locate the wireless device.

An aspect of the present disclosure relates to systems and methods for determining an occurrence probability of a target incident (also referred to herein as a target incident occurrence probability) when a service provider serves a service requester associated with an order. To this end, the systems may extract target order features of the order, target requester features of the service requester, and target provider requester features of the service providers. Then the systems may obtain a prediction model for determining the target incident occurrence probability. The prediction model may be trained using training data. The training data may include a plurality of positive samples and a plurality of negative samples. In some embodiments, the positive samples and the negative samples are imbalanced. The systems may determine balanced samples using a sample balancing technique. Finally, the systems may determine the target incident occurrence probability using the prediction model based on the target order features, the target requester features, and/or the target provider features. Because the samples used to train the prediction model are balanced, the systems may improve an accuracy of predicting the target incident occurrence probability using the prediction model. The systems may also obtain a plurality of orders and allocate orders based on the target incident occurrence probabilities so determined. Because the target incident occurrence probabilities are considered when allocating the orders, the systems may reduce the possibility of a target incident, thereby improving the service quality and/or experience of service requesters and/or service providers.

It should be noted that online to offline services, such as online taxi-hailing services, is a new form of services rooted only in post-Internet era. It provides detailed information of a user terminal that could raise only in post-Internet era. It provides technical solutions to service requesters and service providers that could raise only in post-Internet era. In pre-Internet era, when a service requester (e.g., a passenger) hails a taxi on the street, the taxi request and acceptance occur only between the passenger and one taxi driver that sees the passenger. If the passenger hails a taxi through a telephone call, the service request and acceptance may occur only between the passenger and one service provider (e.g., one taxi company or agent). Online taxi, however, allows a user of the service to distribute a service request real-time and automatically to a vast number of individual service providers (e.g., taxi) distance away from the user. It also allows a plurality of service providers to respond to the service request simultaneously and in real-time. Therefore, through the Internet, the online to offline service system may provide a much more efficient transaction platform for the service requesters and the service providers that may never meet in a traditional pre-Internet transportation service system. When the system receives an order from a service requester, the system may determine target incident occurrence probabilities when different service providers serve the service requester. Then the system may select a suitable service provider to serve the service requester based on the target incident occurrence probabilities the target to make the allocation of orders more reasonable.

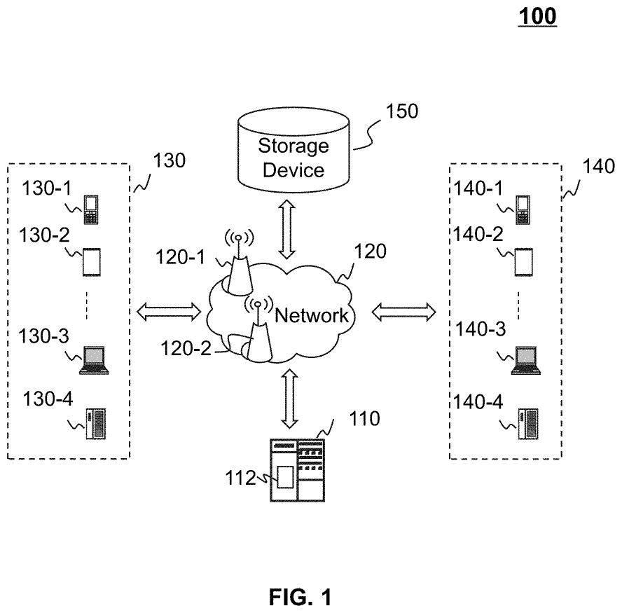

FIG. 1 is a block diagram of an exemplary online to offline service artificial intelligent system according to some embodiments of the present disclosure. For example, the online to offline service artificial intelligent system (also referred to herein as the artificial intelligent system or the Al system) 100 may be an online transportation service platform for transportation services such as taxi hailing service, chauffeur service, express car service, carpool service, bus service, driver hire, and shuttle service. The artificial intelligent system 100 may include a server 110, a network 120, a requester terminal 130, a provider terminal 140, and a storage device 150. The server 110 may include a processing device 112.

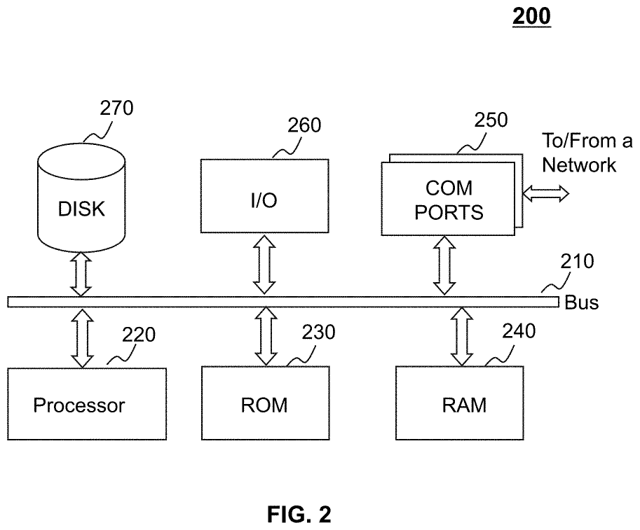

In some embodiments, the server 110 may be a single server, or a server group. The server group may be centralized, or distributed (e.g., the server 110 may be a distributed system). In some embodiments, the server 110 may be local or remote. For example, the server 110 may access information and/or data stored in the requester terminal 130, the provider terminal 140, and/or the storage device 150 via the network 120. As another example, the server 110 may be directly connected to the requester terminal 130, the provider terminal 140, and/or the storage device 150 to access information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device having one or more components illustrated in FIG. 2 in the present disclosure.

In some embodiments, the server 110 may include a processing device 112. The processing device 112 may process information and/or data relating to the service request to perform one or more functions of the server 110 described in the present disclosure. For example, the processing device 112 may determine an occurrence probability of a target incident when a service provider serves a service requester. The target incident may include a vicious incident, e.g., assault, sexual harassment, killing, drunkenness, rape, robbery, etc. As another example, the processing device 112 may also train a prediction model for determining the occurrence probability of the target incident. As still another example, the processing device 112 may also allocate one or more orders based at least in part on the occurrence probability of the target incident.

In some embodiments, the processing device 112 may include one or more processing devices (e.g., single-core processing device(s) or multi-core processor(s)). Merely by way of example, the processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the artificial intelligent system 100 (e.g., the server 110, the requester terminal 130, the provider terminal 140, and/or the storage device 150) may transmit information and/or data to other component(s) in the artificial intelligent system 100 via the network 120. For example, the server 110 may obtain/acquire service request data from the requester terminal 130 via the network 120. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee™ network, a near field communication (NFC) network, a global system for mobile communications (GSM) network, a code-division multiple access (CDMA) network, a time-division multiple access (TDMA) network, a general packet radio service (GPRS) network, an enhanced data rate for GSM evolution (EDGE) network, a wideband code division multiple access (WCDMA) network, a high speed downlink packet access (HSDPA) network, a long term evolution (LTE) network, a user datagram protocol (UDP) network, a transmission control protocol/Internet protocol (TCP/IP) network, a short message service (SMS) network, a wireless application protocol (WAP) network, a ultra wide band (UWB) network, an infrared ray, or the like, or any combination thereof. In some embodiments, the server 110 may include one or more network access points. For example, the server 110 may include wired or wireless network access points such as base stations and/or internet exchange points 120-1, 120-2, . . . , through which one or more components of the artificial intelligent system 100 may be connected to the network 120 to exchange data and/or information.

The requester terminal 130 may be used by a passenger to request an online to offline service. For example, a user of the requester terminal 130 may use the requester terminal 130 to transmit a service request for himself/herself or another user, or receive service and/or information or instructions from the server 110. The provider terminal 140 may be used by a driver to reply an online to offline service. For example, a user of the provider terminal 140 may use the provider terminal 140 to receive a service request from the requester terminal 130, and/or information or instructions from the server 110. In some embodiments, the terms “user,” “passenger,” “customer,” “service requestor,” and “service requester” may be used interchangeably, and the terms “user,” “driver,” and the “service provider” may be used interchangeably. In some embodiments, the user may refer to a service requester or a service provider according to a specific situation. In some embodiments, the terms “user terminal,” “passenger terminal,” “requester terminal,” and “requestor terminal” may be used interchangeably. In some embodiments, the terms “user terminal,” “driver terminal,” and “provider terminal” may be used interchangeably.

In some embodiments, the requester terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, built-in device in the motor vehicle 130-4 may include an onboard computer, an onboard television, etc. In some embodiments, the requester terminal 130 may be a wireless device with positioning technology for locating the position of the user and/or the requester terminal 130.

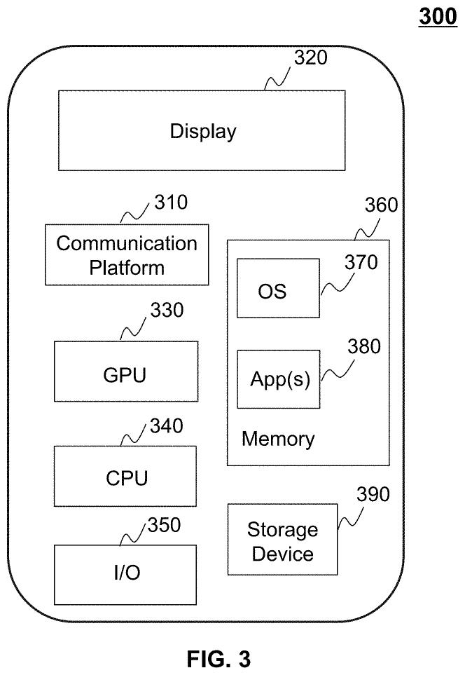

In some embodiments, the requester terminal 130 may further include at least one network port. Via the at least one network port, the requester terminal 130 may be configured to send information to and/or receive information from one or more components in the artificial intelligent system 100 (e.g., the server 110, the storage device 150) via the network 120. In some embodiments, the requester terminal 130 may be implemented on a computing device 200 having one or more components illustrated in FIG. 2, or a mobile device 300 having one or more components illustrated in FIG. 3 in the present disclosure.

In some embodiments, the provider terminal 140 may include a mobile device 140-1, a tablet computer 140-2, a laptop computer 140-3, a built-in device in a motor vehicle 140-4, or the like, or any combination thereof. In some embodiments, the mobile device 140-1 may include a smart home device, a wearable device, a smart mobile device, a virtual reality device, an augmented reality device, or the like, or any combination thereof. In some embodiments, the provider terminal 140 may be similar to, or the same device as the requester terminal 130. In some embodiments, the provider terminal 140 may be a wireless device with positioning technology for locating the position of the driver and/or the provider terminal 140. In some embodiments, the requester terminal 130 and/or the provider terminal 140 may communicate with other positioning device to determine the position of the passenger, the requester terminal 130, the driver, and/or the provider terminal 140. In some embodiments, the requester terminal 130 and/or the provider terminal 140 may transmit positioning information to the server 110.

In some embodiments, the provider terminal 140 may further include at least one network port. Via the at least one network port, the provider terminal 140 may be configured to send information to and/or receive information from one or more components in the artificial intelligent system 100 (e.g., the server 110, the storage device 150) via the network 120. In some embodiments, the provider terminal 140 may be implemented on a computing device 200 having one or more components illustrated in FIG. 2, or a mobile device 300 having one or more components illustrated in FIG. 3 in the present disclosure.

The storage device 150 may store data and/or instructions. In some embodiments, the storage device 150 may store data obtained/acquired from the requester terminal 130 and/or the provider terminal 140. In some embodiments, the storage device 150 may store data and/or instructions that the server 110 may execute or use to perform exemplary methods described in the present disclosure. In some embodiments, the storage device 150 may include a mass storage device, a removable storage device, a volatile read-and-write memory, a read-only memory (ROM), or the like, or any combination thereof. Exemplary mass storage device may include a magnetic disk, an optical disk, a solid-state drive, etc. Exemplary removable storage device may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may include at least one network port to communicate with other devices or components in the artificial intelligent system 100. For example, the storage device 150 may be connected to the network 120 to communicate with one or more components in the artificial intelligent system 100 (e.g., the server 110, the requester terminal 130, the provider terminal 140, etc.) via the at least one network port. One or more components in the artificial intelligent system 100 may access the data or instructions stored in the storage device 150 via the network 120. In some embodiments, the storage device 150 may be directly connected to or communicate with one or more components in the on demand service system 100 (e.g., the server 110, the requester terminal 130, the provider terminal 140, etc.). In some embodiments, the storage device 150 may be part of the server 110.

In some embodiments, one or more components in the artificial intelligent system 100 (e.g., the server 110, the requester terminal 130, the provider terminal 140, etc.) may have a permission to access the storage device 150. In some embodiments, one or more components in the artificial intelligent system 100 may read and/or modify information related to the passenger, driver, and/or the public when one or more conditions are met. For example, the server 110 may read and/or modify one or more users' information after a service. As another example, the provider terminal 140 may access information related to the passenger when receiving a service request from the requester terminal 130, but the provider terminal 140 may not modify the relevant information of the passenger.

In some embodiments, one or more components of the online to offline service artificial intelligent system 100 (e.g., the server 110, the requester terminal 130, the provider terminal 140, or the storage device 150) may communicate with each other in the form of electronic and/or electromagnetic signals, through wired and/or wireless communication. In some embodiments, the artificial intelligent system 100 may further include at least one first information exchange port corresponding to a service requesting system and at least one second information exchange port corresponding to a service providing system. The service requesting system may include the requester terminal 130 and the network 120. The service providing system may include the provider terminal 140 and the network 120. Via the at least one first information exchange port, information relating to the service request (e.g., in the form of electronic signals and/or electromagnetic signals) may be exchanged between any electronic devices in the artificial intelligent system 100. For example, via the at least one first information exchange port, the server 110 may receive an order from a requester terminal 130 through wireless communication between the server 110 and the provider terminal 130. Via the at least one second information exchange port information (e.g., in the form of electronic signals and/or electromagnetic signals) may be exchanged between any electronic devices in the artificial intelligent system 100. For example, via the at least one second information exchange port, the server 110 may send electromagnetic signals including information of the allocated orders to the provider terminal 140 through wireless communication. In some embodiments, the at least one first information exchange port and/or the at least one second information exchange port may be one or more of an antenna, a network interface, a network port, or the like, or any combination thereof. For example, the at least one first information exchange port and/or the at least one second information exchange port may be a network port connected to the server 110 to transmit and/or receive information.

In some embodiments, information exchanging of one or more components in the artificial intelligent system 100 may be achieved by way of requesting a service. The object of the service request may be any product. In some embodiments, the product may be a tangible product, an intangible product, a service, etc. The tangible product may include food, medicine, commodity, chemical product, electrical appliance, clothing, car, housing, luxury, or the like, or any combination thereof. The intangible product may include a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistant (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

One of ordinary skill in the art would understand that when an element of the artificial intelligent system 100 performs, the element may perform through electrical signals and/or electromagnetic signals. For example, when a requester terminal 130 processes a task, such as sending a service request, the requester terminal 130 may operate logic circuits in its processor to perform such task. When the requester terminal 130 transmits out the service request to the server 110, a processor of the server 110 may generate electrical signals encoding the service request. The processor of the server 110 may then transmit the electrical signals to at least one first information exchange port of a first target system (e.g., a service requesting system) associated with the server 110. The server 110 may communicate with the service requesting system via a wired network, the at least one first information exchange port may be physically connected to a cable, which may further transmit the electrical signals to an input port (e.g., an information exchange port) of the requester terminal 130. If the server 110 communicates with the service requesting system via a wireless network, the at least one first information exchange port of the service requesting system may be one or more antennas, which may convert the electrical signal to an electromagnetic signal. Similarly, a provider terminal 140 may process a task through operation of logic circuits in its processor, and receive an instruction and/or service request from the server 110 in the form of an electrical signal or an electromagnet signal. A processor of the server 110 may generate electrical signals encoding inforamtion of allocating orders and transmit the electrical signals to at least one second information exchange port of a second target system (e.g., a service providing system) associated with the server 110. The server 110 may communicate with the service providing system via a wired network, the at least one second information exchange port may be physically connected to a cable, which may further transmit the electrical signals to an input port (e.g., an inforamtion exchange port) of the provider terminal 140. If the server 110 communicates with the service providing system via a wireless network, the at least one second information exchange port of the service providing system may be one or more antennas, which may convert the electrical signal to an electromagnetic signal. Within an electronic device, such as the requester terminal 130, the provider terminal 140, and/or the server 110, when a processor thereof processes an instruction, transmits out an instruction, and/or performs an action, the instruction and/or action is conducted via electrical signals. For example, when the processor retrieves data from or saves data in a storage medium, it may transmit out electrical signals to a read/write device of the storage medium, which may read and/or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and software components of a computing device on which the server 110, the requester terminal 130, and/or the provider terminal 140 may be implemented according to some embodiments of the present disclosure. For example, the processing device 112 may be implemented on the computing device 200 and configured to perform functions of the processing device 112 disclosed in the present disclosure.

The computing device 200 may be used to implement an online to offline system for the present disclosure. The computing device 200 may implement any component of the online to offline service as described herein. In FIG. 2, only one such computer device is shown purely for convenience purposes. One of ordinary skill in the art would understood at the time of filing of this application that the computer functions relating to the online to offline service as described herein may be implemented in a distributed fashion on a number of similar platforms, to distribute the processing load.

The computing device 200, for example, may include COM ports 250 connected to and from a network connected thereto to facilitate data communications. The computing device 200 may also include a processor (e.g., the processor 220), in the form of one or more processors, for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. The exemplary computer platform may include an internal communication bus 210, a program storage and a data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, the RAM 240, and/or other type of non-transitory storage medium to be executed by the processor 220. The methods and/or processes of the present disclosure may be implemented as the program instructions. The computing device 200 may also include an I/O component 260, supporting input/output between the computer and other components therein. The computing device 200 may also receive programming and data via network communications.

Merely for illustration, only one processor 220 is described in the computing device 200. However, it should be noted that the computing device 200 in the present disclosure may also include multiple processors, thus operations and/or method steps that are performed by one processor 220 as described in the present disclosure may also be jointly or separately performed by the multiple processors. For example, if in the present disclosure the processor 220 of the computing device 200 executes both step A and step B, it should be understood that step A and step B may also be performed by two different processors jointly or separately in the computing device 200 (e.g., the first processor executes step A and the second processor executes step B, or the first and second processors jointly execute steps A and B).

FIG. 3 is a schematic diagram illustrating exemplary hardware and/or software components of an exemplary device on which the requester terminal 130 and/or the provider terminal 140 may be implemented according to some embodiments of the present disclosure. The device may be a mobile device, such as a mobile phone of a passenger or a driver. The device may also be an electronic device mounted on a vehicle driving by the driver. As illustrated in FIG. 3, the device 300 may include a communication platform 310, a display 320, a graphic processing unit (GPU) 330, a central processing unit (CPU) 340, an I/O 350, a memory 360, and a storage device 390. The CPU may include interface circuits and processing circuits similar to the processor 220. In some embodiments, any other suitable component, including but not limited to a system bus or a controller (not shown), may also be included in the device 300. In some embodiments, a mobile operating system 370 (e.g., iOS™, Android™, Windows Phone™, etc.) and one or more applications 380 may be loaded into the memory 360 from the storage device 390 in order to be executed by the CPU 340. The applications 380 may include a browser or any other suitable mobile apps for receiving and rendering information relating to an online to offline service or other information from the server 110, and transmitting information relating to an online to offline service or other information to the server 110. User interactions with the information stream may be achieved via the I/O 350 and provided to the server 110 and/or other components of the online artificial intelligent system 100 via the network 120.

To implement various modules, units, and their functionalities described in the present disclosure, computer hardware platforms may be used as the hardware platform(s) for one or more of the elements described herein (e.g., the online to artificial intelligent system 100, and/or other components of the artificial intelligent system 100 described with respect to FIGS. 1-9. The hardware elements, operating systems and programming languages of such computers are conventional in nature, and it is presumed that those skilled in the art are adequately familiar therewith to adapt those technologies to allocate orders as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

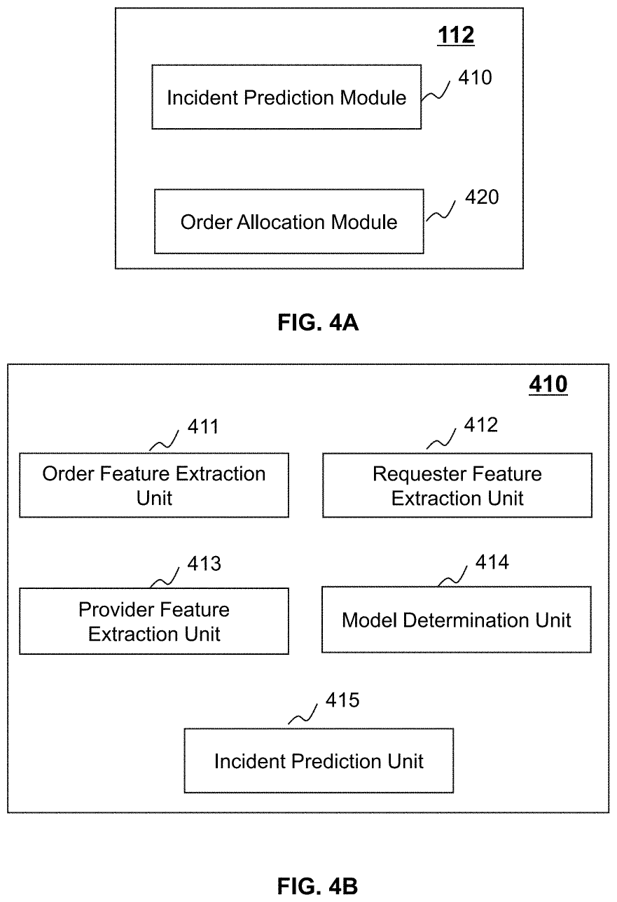

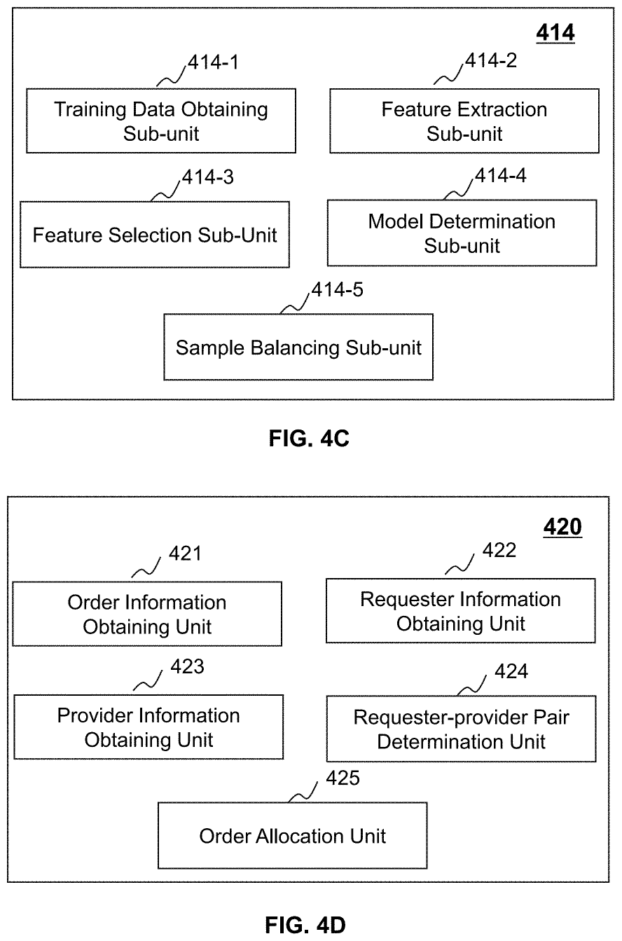

FIG. 4A is a block diagram illustrating an exemplary processing device according to some embodiments of the present disclosure. In some embodiments, the processing device 112 may include an incident prediction module 410 and/or an order allocation module 420. The incident prediction module 410 may determine a requester-provider pair by associating one service requester with one service provider. The incident prediction module 410 may predict an occurrence probability of a target incident when a service provider serves a service requester. The occurrence probability of the target incident (also referred to herein as the target incident occurrence probability) may reflect a possibility that the target incident occurs when the service provider serves the service requester. The target incident may include a vicious incident, e.g., assault, sexual harassment, killing, drunkenness, rape, robbery, etc.

The order allocation module 420 may allocate an order based at least in part on occurrence probabilities of the target incident(s) associated with the order. In some embodiments, the order allocation module 420 may allocate a target order based further on other factors including, e.g., a distance between a location of the service provider and a starting location of the target order, a length of time moving from the location of the service provider to the starting location of the target order, traffic information, provider features (e.g., the service type of the service provider, the vehicle type of the service provider, the service score of the service provider, etc.), the service provider's demands (e.g., the gender of a service requester, the destination(s) of orders that the service provider prefers or accepts, etc.), the service requester's demands (e.g., the gender of a service provider), etc. In some embodiments, the order allocation module 420 may assign weights to the occurrence probability and such other factors to determine how to allocate the target order. In some embodiments, for a same target order, the weights assigned to the target incident occurrence probability and one or more of such other factors may be the same or different. In some embodiments, the weight assigned to the target incident occurrence probability associated with the target order may be larger than the weights assigned to one or more of such other factors. In some embodiments, for different target orders, the weights assigned to the target incident occurrence probabilities associated with the target orders may be the same or different.

The modules in the processing device 112 may be connected to or communicate with each other via a wired connection or a wireless connection. The wired connection may be a metal cable, an optical cable, a hybrid cable, or the like, or any combination thereof. The wireless connection may be a Local Area Network (LAN), a Wide Area Network (WAN), a Bluetooth™ network, a ZigBee™ network, a Near Field Communication (NFC), or the like, or any combination thereof. In some embodiments, the processing device 112 may also include other modules. In some embodiments, the incident prediction module 410 and the order allocation module 420 may be implemented on different processors in the server 110. In some embodiments, the incident prediction module 410 and the order allocation module 420 may be implemented on a single processor in the server 110.

FIG. 4B is a block diagram illustrating an exemplary incident prediction module according to some embodiments of the present disclosure. The incident prediction module 410 may include an order feature extraction unit 411, a requester feature extraction unit 412, a provider feature extraction unit 413, a model determination unit 414, and/or an incident prediction unit 415.

The order feature extraction unit 411 may extract features of an order. In some embodiments, the order feature extraction unit 411 may extract target order features of an order. The target order features may be deemed highly correlated with a prediction of a target incident occurrence probability of an order. The order extraction unit 411 may extract the target order features from information relating to the order. The information relating to the order may include a starting location of the order, the destination of the order, a route from the starting location to the destination, neighborhood(s) along the route, a starting time of the order, an estimated time of arrival of the order, a type of the order, a service type relating to the order, or the like, or any combination thereof. The type of the order may include a real-time order or a reservation of a service for a future time (or referred to herein as a reservation). The service type may include a taxi service, an express service, a car service with a special accommodation (e.g., wheelchair accessible, car seat equipped, a certain occupancy capacity, etc.), or the like, or any combination thereof.

The requester feature extraction unit 412 may extract features relating to a service requester. In some embodiments, the requester feature extraction unit 412 may extract target requester features of a service requester. The requester feature extraction unit 412 may extract the target requester features from information relating to the service requester. The information relating to the service requester may include a displayed name (e.g., a nickname), age, a gender, a telephone number, a brand of a telephone of the service requester, an occupation, a profile image, a documentation number (e.g., an identify card number, etc.), a third-party account (e.g., an email account), habits/preferences, locations that are often accessed by the service requester (e.g., a hotel, a guesthouse, a bar, a karaoke television (KTV) club, etc.), the count of orders placed and subsequently cancelled by the service requester of all time or within a specific period of time (e.g., the past week(s), the past month(s), the past year(s), etc.), a count and/or frequency of complaints submitted by the service requester or being complained submitted by service providers of all time or within a specific period of time (e.g., the past week(s), the past month(s), the past year(s), etc.), a criminal record, information posted on forums, blogs, or social networks by the service requester or relating to the service requester, or the like, or any combination thereof.

The provider feature extraction unit 413 may extract features relating to a service provider. In some embodiments, the provider feature extraction unit 413 may extract target provider features of a service provider. The provider feature extraction unit 413 may extract target provider features from information relating to the service provider. The information relating to the service provider may include a displayed name (e.g., a nickname), age, a gender, a telephone number, a brand of a telephone of the service provider, an occupation, an e-mail address, a profile image, a documentation number (e.g., a driver's license number, an identity card number, etc.), a third-party account (e.g., an email account), a vehicle type, a vehicle age, a license plate, a certification status in the artificial intelligent system 100, driving experience, an endorsement, habits/preferences, locations that are often accessed by the service provider (e.g., a hotel, a guesthouse, a bar, a KTV club, etc.), the count of orders accepted and subsequently cancelled by the service provider of all time or within a specific period of time (e.g., the past week(s), the past month(s), the past year(s), etc.), a count and/or frequency of complaints submitted by the service provider or being complained of submitted by service requesters, a criminal record, a rating, information posted on forums, blogs, or social networks by the service provider or relating to the service provider, or the like, or any combination thereof.

The model determination unit 414 may determine a prediction model for determining a probability that a target incident occurs. In some embodiments, the model determination unit 414 may also obtain the prediction model from a storage device (e.g., the storage device 150, the ROM 230, the RAM 240) of the artificial intelligent system 100. The model determination unit 414 may train the prediction model using one or more machine learning algorithms. The machine learning algorithm may include a neural network algorithm, a regression algorithm, a decision tree algorithm, a deep learning algorithm, or the like, or any combination thereof. Merely by way of example, the prediction model may be an eXtreme Gradient Boosting (Xgboost) model.

The incident prediction unit 415 may determine the occurrence probability that a target incident occurs using the prediction model based on the target order features, the target requester features, and/or the target provider features.

The units of the incident prediction module 410 may be connected to or communicate with each other via a wired connection or a wireless connection. The wired connection may be a metal cable, an optical cable, a hybrid cable, or the like, or any combination thereof. The wireless connection may be a Local Area Network (LAN), a Wide Area Network (WAN), a Bluetooth™ network, a ZigBee™ network, a Near Field Communication (NFC), or the like, or any combination thereof. Two or more of the units of the incident prediction module 410 may be combined into a single unit, and any one of the units may be divided into two or more sub-units. For example, the order feature extraction unit 411, the requester feature extraction unit 412, and/or the provider feature extraction unit 413 may be integrate into a single unit to extract features (e.g., the target order features, the target requester features, the target provider features) relating to an order, a service requester, and/or a service provider. In some embodiments, the incident prediction module 410 may also include other units. For example, the incident prediction module 410 may include a communication unit to communicate with other modules or units of the artificial intelligent system 100, e.g., the requester terminal 130, the provider terminal 140, the storage 140, etc.

FIG. 4C is a block diagram illustrating an exemplary model determination unit according to some embodiments of the present disclosure. In some embodiments, the model determination unit 414 may include a training data obtaining sub-unit 414-1, a feature extraction unit sub-unit 414-2, a feature selection sub-unit 414-3, a model determination sub-unit 414-4, and/or a sample balancing sub-unit 414-5.

The training data obtaining sub-unit 414-1 may obtain the training data from the storage device 150 or another storage device in the server 110 or a storage device external to the artificial intelligent system 100. The training data may be historical data relating to a plurality of historical transactions occurring on the online to offline service platform. Each of the plurality of historical transactions may relate to a historical order initiated by a service requester and accepted by a service provider. Therefore, the information relating to each historical transaction may relate to a historical order, a service requester, and a corresponding service provider. The training data may also include historical incident data corresponding to each of the plurality of historical transactions. The historical incident data may include whether an incident occurred, the type of an incident (or referred to herein as an incident type), a degree of seriousness of an incident (or referred to herein as an incident degree), or the like, or any combination thereof. The incident type may include assault, sexual harassment, killing, drunkenness, rape, robbery, etc. The incident degree may include very serious, serious, normal, slight, very slight, etc. The training data may include a plurality of positive samples and a plurality of negative samples. The positive samples may refer to samples in which the target incident has not occurred. The negative samples may refer to samples in which the target incident has occurred.

The feature extraction sub-unit 414-2 may extract a plurality of candidate features from the training data. The candidate features may include candidate order features, candidate requester features, and candidate provider features. The feature extraction sub-unit 414-2 may extract the candidate order features from information relating to the historical orders. The feature extraction sub-unit 414-2 may extract the candidate requester features from information relating to service requesters associated with the historical orders. The feature extraction sub-unit 414-2 may extract the candidate provider features from information relating to service providers who responded to, accepted, and/or provided services in the historical orders.

The feature selection sub-unit 414-3 may determine one or more target features from the plurality of candidate features using a feature selection algorithm. The feature selection algorithm may include a forward feature selection, a backward feature elimination, a recursive feature elimination, etc. The feature selection sub-unit 414-3 may determine a precision rate, a recall rate, and/or an accuracy rate of the prediction model through adding a feature or remove a feature using the feature selection algorithm to determine the target features.

The model determination sub-unit 414-4 may obtain the one or more target features of the plurality of positive samples and the one or more target features of the plurality of negative samples from the feature selection sub-unit 414-3. The model determination sub-unit 414-4 may obtain the historical incident data of the plurality of positive samples and the plurality of negative samples from the training data obtaining sub-unit 414-1. The model determination sub-unit 414-4 may generate the prediction model based on the one or more target features of the plurality of positive samples, the one or more target features of the plurality of negative samples, and/or the historical incident data of the plurality of positive samples and the plurality of negative samples. For example, the model determination sub-unit 414-4 may input the one or more target features of positive samples and the one or more target features of the plurality of negative samples into a prediction model (also referred to herein as an initial prediction model) and generate prediction results corresponding to the target features, then the model determination sub-unit 414-4 may generate a loss function based on the prediction results with the historical incident data of plurality of positive samples and the plurality of negative samples. Then the model determination sub-unit 414-4 may determine whether the loss function satisfies a condition. In some embodiments, the condition may be whether the loss function is smaller than a predetermined threshold. When the loss function is smaller than the predetermined threshold, the model determination sub-unit 414-4 may designate the initial prediction model as the prediction model, i.e., the prediction model has been trained well. When the loss function is larger than the predetermined threshold, the model determination sub-unit 414-4 may modify the initial prediction model and use the training data or obtain different training data to generate an updated prediction model until the updated prediction model meets the condition. In some embodiments, when the loss function is equal to the predetermined threshold, the model determination sub-unit 414-4 may deem that the condition is satisfied and designate the initial prediction model as the prediction model. In some embodiments, when the loss function is equal to the predetermined threshold, the model determination sub-unit 414-4 may the model determination sub-unit 414-4 may deem that the condition is not satisfied and continue to train the prediction model to generate an updated prediction model until the updated prediction model meets the condition. In some embodiments, when the present disclosure relates to compare a parameter with a threshold and make a determination based on the values of the parameter and the threshold (when the parameter is larger than/higher than/more than the threshold, determine a decision A; when the parameter is smaller than/lower than/less than the threshold, determine a decision B different from the decision A), the case in which the parameter is equal to the threshold can be classified either way.

The sample balancing sub-unit 414-5 may determine whether the training data includes an imbalanced sample composition. For example, the sample balancing sub-unit 414-5 may obtain a count of positive samples and a count of negative samples. The sample balancing sub-unit 414-5 may generate a ratio (also referred to herein as a sample ratio) between the count of positive samples and the count of negative samples. The sample balancing sub-unit 414-5 may determine whether the sample ratio exceeds a ratio threshold. When the sample balancing sub-unit 414-5 determine that the sample ratio exceeds the ratio threshold, the sample balancing sub-unit 414-5 may determine that the training data includes imbalanced samples (or referred to herein as an imbalanced sample composition). In some embodiments, the sample balancing sub-unit 414-5 may balance the sample composition based on the training data using a sample balancing technique.

The sub-units of the model determination unit 414 may be connected to or communicate with each other via a wired connection or a wireless connection. The wired connection may be a metal cable, an optical cable, a hybrid cable, or the like, or any combination thereof. The wireless connection may be a Local Area Network (LAN), a Wide Area Network (WAN), a Bluetooth™ network, a ZigBee™ network, a Near Field Communication (NFC), or the like, or any combination thereof. Two or more of the sub-units of the model determination unit 414 may be combined into a single sub-unit, and any one of the sub-units may be divided into two or more components. For example, the feature extraction sub-unit 414-2 may be divided into three components, e.g., an order feature extraction component, a requester feature extraction component, a provider feature extraction component. The order feature extraction component may extract candidate order features from information relating to the historical orders. The requester feature extraction component may extract the candidate requester features from information relating to service requesters associated with the historical orders. The provider feature extraction component may extract the candidate provider features from information relating to service providers corresponding to the historical orders. In some embodiments, the feature extraction sub-unit 414-2 and the feature selection sub-unit 414-3 may be integrated into a single unit. In some embodiments, the feature extraction sub-unit 414-2, the order feature extraction unit 411, the requester feature extraction unit 412, and/or the provider feature extraction unit 413 may be integrate into a single unit to extract features relating to an order, a service requester, and/or a service provider.

FIG. 4D is a block diagram illustrating an exemplary order allocation module according to some embodiments of the present disclosure. In some embodiments, the order allocation module 420 may include an order information obtaining unit 421, the requester information obtaining unit 422, the provider information obtaining unit 423, a requester-provider pair determination unit 424, and/or the order allocation unit 425.

The order information obtaining unit 421 may obtain information relating to one or more target orders to be allocated from one or more service requester terminals 130. The information relating to each of the target order may include a starting location of the target order, the destination of the target order, a route from the starting location to the destination of the target order, neighborhood(s) along the route of the target order, a starting time of the target order, an estimated time of arrival of the target order, a type of the target order, a service type relating to the target order, or the like, or any combination thereof. The type of the target order may include a real-time order or a reservation for a service in a future time. The service type may include a taxi service, an express service, a car service with a special accommodation (e.g., wheelchair accessible, car seat equipped, a certain occupancy capacity, etc.), or the like, or any combination thereof.

The requester information obtaining unit 422 may obtain information relating to the service requesters associated with the one or more target orders. For example, the requester information obtaining unit 422 may also obtain the information relating to the service requesters from the storage device 150, another storage device in the server 110, or a storage device external to the system 100. The information relating to the service requester may include a displayed name (e.g., a nickname), age, a gender, a telephone number, a brand of a telephone of the service requester, an occupation, a profile image, a documentation number (e.g., an identify card number, etc.), a third-party account (e.g., an email account), habits/preferences, locations that often accessed by the service requester (e.g., a hotel, a guesthouse, a bar, a KTV club, etc.), the count of orders placed and subsequently cancelled by the service requester of all time or within a specific period of time (e.g., the past week(s), the past month(s), the past year(s), etc.), a count and/or frequency of complaints submitted by the service requester or being complained of submitted by service providers of all time or within a specific period of time (e.g., the past week(s), the past month(s), the past year(s), etc.), a criminal record, information posted on forums, blogs, or social networks by the service requester or relating to the service requester, or the like, or any combination thereof.

The provider information obtaining unit 423 may identify a plurality of candidate service providers available to accept the one or more target orders. The provider information obtaining unit 423 may also obtain information relating to the plurality of candidate service providers. In some embodiments, the provider information obtaining unit 423 may obtain the information relating to the plurality of candidate service providers from the storage device 150 or other storage device in the server 110. The information relating to each of the plurality of candidate service providers may include a displayed name (e.g., a nickname), age, a gender, a telephone number, a brand of a telephone of the candidate service provider, an occupation, an e-mail address, a profile image, a documentation number (e.g., a driver's license number, an identity card number, etc.), a third-party account (e.g., an email account), a vehicle type, a vehicle age, a license plate, a certification status in the artificial intelligent system 100, driving experience, an endorsement, habits/preferences, locations that are often accessed by the service provider (e.g., a hotel, a guesthouse, a bar, a KTV club, etc.), the count of orders accepted and subsequently cancelled by the service provider of all time or within a specific period of time (e.g., the past week(s), the past month(s), the past year(s), etc.), a count and/or frequency of complaints submitted by the service provider or being complained of submitted by service requesters, a criminal record, a rating, information posted on forums, blogs, or social networks by the candidate service provider, or the like, or any combination thereof.

In some embodiments, the order allocation module 420 may also include a requester-provider pair determination unit 424. The order allocation module 420 may determine candidate requester-provider pairs by associating each of the one or more target service requesters with each of the plurality of candidate service providers. It should be noted that the requester-provider pair determination unit 424 may also be implemented on the incident prediction module 410, or other component of the processing device 112. The order allocation unit 425 may obtain target incident occurrence probabilities relating to the candidate requester-provider pairs from the incident prediction module 410. The order allocation unit 425 may allocate the target orders based at least in part on the target incident occurrence probabilities and corresponding candidate requester-provider pairs. In some embodiments, the order allocation unit 425 may determine whether to allocate a target order to a service provider according to other factors including, e.g., a distance between a location of the service provider and a starting location of the target order, a length of time moving from the location of the service provider to the starting location of the target order, traffic information, provider features (e.g., the service type of the service provider, the vehicle type of the service provider, the service score of the service provider, etc.), the service provider's demands (e.g., gender of service requesters, destinations of orders that the service provider prefers or accepts, etc.), the service requester's demands (e.g., the gender of a service provider), etc. In some embodiments, the order allocation unit 425 may assign weights to the target incident occurrence probabilities and one or more of such other factors to decide how to allocate the target orders. In some embodiments, for a same target order, the weights assigned to the target incident occurrence probability and one or more of such other factors may be the same or different. In some embodiments, the weight assigned to the target incident occurrence probability associated with the target order may be larger than the weights assigned to one or more of such other factors. In some embodiments, for different target orders, the weights assigned to the target incident occurrence probabilities associated with the target orders may be the same or different.

The units of the order allocation module 420 may be connected to or communicate with each other via a wired connection or a wireless connection. The wired connection may be a metal cable, an optical cable, a hybrid cable, or the like, or any combination thereof. The wireless connection may be a Local Area Network (LAN), a Wide Area Network (WAN), a Bluetooth™ network, a ZigBee™ network, a Near Field Communication (NFC), or the like, or any combination thereof.

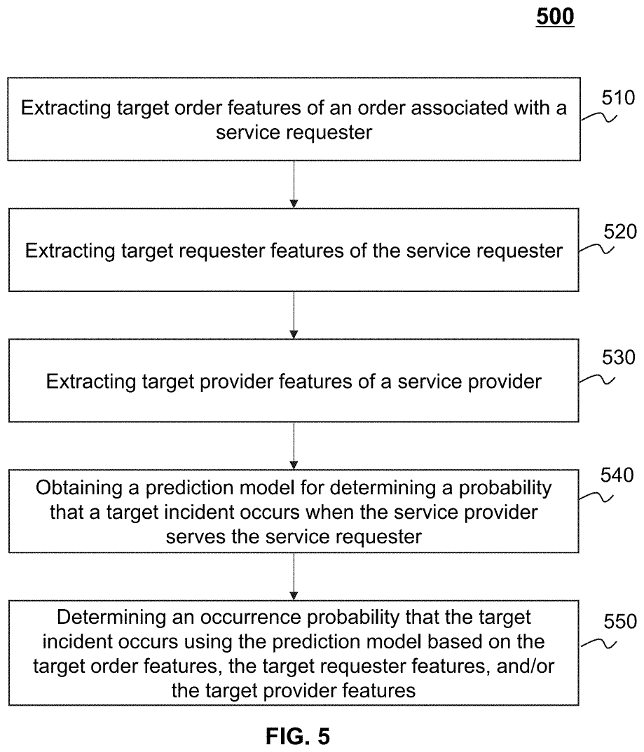

FIG. 5 is a flowchart illustrating another exemplary process for determining an occurrence probability that a target incident occurs according to some embodiments of the present disclosure. In some embodiments, the process 650 may be implemented in the artificial intelligent system 100 as illustrated in FIG. 1. For example, the process 500 may be stored in the storage device 150 and/or other storage device (e.g., the ROM 230, the RAM 240) as a form of instructions, and invoked and/or executed by the server 110 (e.g., the processing device 112 in the server 110, the processor 220 of the processing device 112 in the server 110, the one or more modules of the processing device 112 in the server 110).

In 510, the processing device 112 (e.g., the order feature extraction unit 411) may extract target order features of an order associated with a service requester. The order feature extraction unit 411 may extract the target order features from information relating to the order. The information relating to the order may include a starting location of the order, the destination of the order, a route from the starting location to the destination, neighborhood(s) the route, a starting time of the order, an estimated time of arrival of the order, a type of the order, a service type relating to the order, or the like, or any combination thereof. The type of the order may include real-time order or a reservation of a service for a future time. The service type may include a taxi service, an express service, a car service with a special accommodation (e.g., wheelchair accessible, car seat equipped, a certain occupancy capacity, etc.), or the like, or any combination thereof. The target features may be highly correlated with the prediction of the target incident occurrence probability.

In some embodiments, the requester terminal 130 of a service requesting system may send and/or transmit an order to the server 110 via at least one first information exchange port. The requester terminal 130 may exchange information with the server 110 through wireless communication. The service requesting system may include the requester terminal 130 and the network 120. The at least one first information exchange port may facilitate a communication between the requester terminal 130 and the server 110 via the network 120. For example, the at least one first information exchange port may be one or more network I/O ports (e.g., antennas) connected to and/or in communication with the server 110. The at least one first information exchange port corresponding to or in communication with the service requesting system may transmit the order to the processing device 112.

In 520, the processing device 112 (e.g., the requester feature extraction unit 412) may extract target requester features of the service requester. In some embodiments, the requester feature extraction unit 412 may extract the target requester features from information relating to the service requester. The information relating to the service requester may include a displayed name (e.g., a nickname), age, a gender, a telephone number, a brand of a telephone of the service requester, an occupation, a profile image, a documentation number (e.g., an identify card number, etc.), a third-party account (e.g., an email account), habits/preferences, a criminal record, locations that are often accessed by the service requester (e.g., a hotel, a guesthouse, a bar, a KTV club, etc.), the count of orders placed and subsequently cancelled by the service requester of all time or within a specific period of time (e.g., the past week(s), the past month(s), the past year(s), etc.), a count and/or frequency of complaints submitted by the service requester or being complained of submitted by service providers of all time or within a specific period of time (e.g., the past week(s), the past month(s), the past year(s), etc.), information posted on forums, blogs, or social networks by the service requester or relating to the service requester, or the like, or any combination thereof.

In 530, the processing device 112 (e.g., the provider feature extraction unit 413) may extract target requester features of a service provider. The target order features target provider features, and the target requester features may be deemed highly correlated with a prediction of a target incident occurrence probability of the order. In some embodiments, the provider feature extraction unit 413 may extract the target provider features from information relating to the service provider. The information relating to the service provider may include a displayed name (e.g., a nickname), age, a gender, a telephone number, a brand of a telephone of the service provider, an occupation, an e-mail address, a profile image, a documentation number (e.g., a driver's license number, an identity card number, etc.), a third-party account (e.g., an email account), a vehicle type, a vehicle age, a license plate, a certification status in the artificial intelligent system 100, driving experience, an endorsement, habits/preferences, locations that are often accessed by the service provider (e.g., a hotel, a guesthouse, a bar, a KTV club, etc.), the count of orders accepted and subsequently cancelled by the service provider of all time or within a specific period of time (e.g., the past week(s), the past month(s), the past year(s), etc.), a count and/or frequency of complaints submitted by the service provider or being complained of submitted by service requesters of all time or within a specific period of time (e.g., the past week(s), the past month(s), the past year(s), etc.), a criminal record, a rating, information posted on forums, blogs, or social networks by the service provider or relating to the service provider, or the like, or any combination thereof. The service score may reflect the service quality of the service provider determined based on feedbacks of one or more service requesters that are served by the service provider. The service score may be a number (e.g., from 0 through 100, from 0 through 10, etc.), a character (e.g., A, B, C, D . . . ), etc.

In 540, the processing device 112 (e.g., the model determination unit 414) may obtain a prediction model for determining a probability that the target incident occurs. In some embodiments, the processing device 112 may obtain the prediction model from a storage device (e.g., the storage device 150, the ROM 230, the RAM 240) of the artificial intelligent system 100.

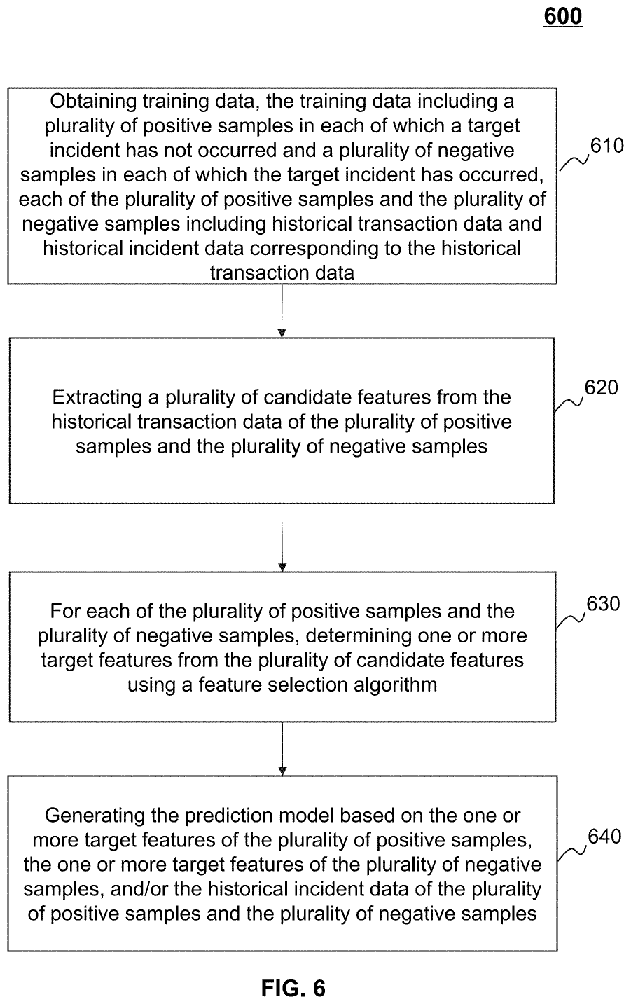

The target incident may be a vicious incident, e.g., assault, sexual harassment, killing, drunkenness, rape, robbery, etc. In some embodiments, the prediction model may be trained in advance. In some embodiments, the prediction model may be trained and/or updated in real time. The model determination unit 414 may train the prediction model using one or more machine learning algorithms. The machine learning algorithm may include a neural network algorithm, a regression algorithm, a decision tree algorithm, a deep learning algorithm, or the like, or any combination thereof. The neural network algorithm may include a recurrent neural network, a perceptron neural network, a Hopfield network, a self-organizing map (SOM), or a learning vector quantization (LVQ), etc. The regression algorithm may include a logistic regression, a stepwise regression, a multivariate adaptive regression spline, a locally estimated scatterplot smoothing, etc. The decision tree algorithm may include a classification and regression tree (CART) algorithm, an Iterative Dichotomiser 3 (ID3) algorithm, a C4.5, a chi-squared automatic interaction detection (CHAID), a decision stump, a random forest, a multivariate adaptive regression spline (MARS), a Gradient Boosting Machine (GBM) algorithm, a Gradient Boost Decision Tree (GBDT) algorithm, an eXtreme Gradient Boosting (Xgboost) algorithm, etc. The deep learning algorithm may include a restricted Boltzmann machine (RBN), a deep belief networks (DBN), a convolutional network, a stacked autoencoders, etc. In some embodiments, the prediction model may be obtained by performing one or more operations described in connection with FIG. 6.

In 550, the processing device 112 (e.g., the incident prediction unit 415) may determine the occurrence probability that the target incident occurs using the prediction model based on the target order features, the target requester features, and/or the target provider features. For example, the processing device 112 may generate a feature vector in a vector space based on the target order features, the target requester features, and/or the target provider features. The feature vector may be used as an input of the prediction model. An output of the prediction model may be the target incident occurrence probability.

In some embodiments, the target incident occurrence probability may be represented as a number (e.g., from 0 through 100, from 0 through 10, etc.). In some embodiments, the target incident occurrence probability may be represented as a character (e.g., A, B, C, D . . . ). The target incident occurrence probability may reflect a possibility that the target incident occurs when a service provider serves a service requester and the rationality of pairing the service requester with the service provider. For brevity, a service provider and a service requester that may be served by the service provider may be referred to as a requester-provider pair. For example, if the target incident occurrence probability is presented as a number, e.g., from 0 through 100 with a small number corresponding to a low target incident occurrence probability and a large number corresponding to a high target incident occurrence probability, a requester-provider pair with a target incident occurrence probability of 30 may be more rational in comparison with a requester-provider pair with a target incident occurrence probability of 60. As another example, if the target incident occurrence probability is presented as A, B, C, or D, . . . corresponding to an increasing target incident occurrence probabilities, respectively, a requester-provider pair with a target incident occurrence probability of “A” may be more rational in comparison with a requester-provider pair with a target incident occurrence probability of “C”.

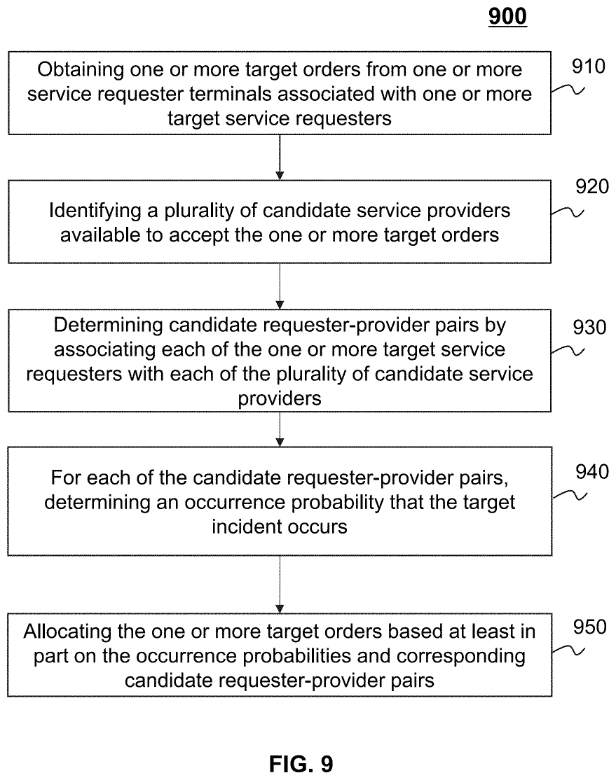

Based on the target incident occurrence probability, the processing device 112 may determine whether to allocate the order associated with the service requester to the service provider. The process of allocating orders based on target incident occurrence probabilities may be found elsewhere in the present disclosure. See, e.g., FIG. 9 and relevant descriptions thereof.

It should be noted that the above description about the process 500 for determining a target incident occurrence probability that a target incident occurs is merely an example, and not intended to be limiting. In some embodiments, the process 500 may be accomplished with one or more additional operations not described, and/or without one or more of the operations discussed. Additionally, the order in which the operations of the process 500 as illustrated in FIG. 5 and described below is not intended to be limiting. For example, operations 510-530 may be performed simultaneously. As another example, operation 540 may be performed before operations 510-530.

FIG. 6 is a flowchart illustrating another exemplary process for generating a prediction model according to some embodiments of the present disclosure. In some embodiments, the process 600 may be implemented in the artificial intelligent system 100 as illustrated in FIG. 1. For example, the process 600 may be stored in the storage device 150 and/or other storage device (e.g., the ROM 230, the RAM 240) as a form of instructions, and invoked and/or executed by the server 110 (e.g., the processing device 112 in the server 110, the processor 220 of the processing device 112 in the server 110, the one or more modules of the processing device 112 in the server 110). In some embodiments, the process 600 and the process 500 may be performed in a same processor of the processing device 112 or in different processors of the processing device 112.

In 610, the processing device 112 (e.g., the training data obtaining sub-unit 414-1) may obtain training data. In some embodiments, the training data obtaining sub-unit 414-1 may obtain the training data from the storage device 150 or other storage device in the server 110 or a storage device external to the artificial intelligent system 100. The training data may be historical data relating to a plurality of historical transactions occurring on the online to offline service platform. Each of the plurality of historical transactions may relate to a historical order initiate by a service requester and accepted by a service provider. Therefore, the information relating to each historical transaction may relate to a historical order, a service requester, and a corresponding service provider. The training data may also include historical incident data corresponding to each of the plurality of historical transactions. The historical incident data may include whether an incident has occurred, an incident type, an incident degree, or the like, or any combination thereof. The incident type may include assault, sexual harassment, killing, drunkenness, rape, robbery, etc. The incident degree may include very serious, serious, normal, slight, very slight, etc.

The training data may include a plurality of positive samples and a plurality of negative samples. The positive samples may refer to samples in which the target incident has not occurred. The negative samples may refer to samples in which the target incident has occurred. It should be noted that the terms “positive sample” and “negative sample” are so defined for illustration purposes and not intended to be limiting.

Each of the plurality of positive samples and the plurality of negative samples may include historical transaction data and historical incident data corresponding to the historical transaction data.

In 620, the processing device 112 (e.g., the feature extraction sub-unit 414-2) may extract a plurality of candidate features from the historical transaction data of the plurality of positive samples and the plurality of negative samples. The candidate features may include candidate order features, candidate requester features, and candidate provider features. The feature extraction sub-unit 414-2 may extract the candidate order features from information relating to the historical orders. The feature extraction sub-unit 414-2 may extract the candidate requester features from information relating to service requesters associated with the historical orders. The feature extraction sub-unit 414-2 may extract the candidate provider features from information relating to service providers corresponding to the historical orders. The candidate order features may include a starting location of each historical order, the destination of each historical order, a route from the starting location to the destination of each historical order, neighborhood along the route of each historical order, a starting time of each historical order, an estimated time of arrival of each historical order, a real time of arrival of each historical order, a type of each historical order, a service type relating to of each historical order, or the like, or any combination thereof. The candidate requester features may include information relating to the service requesters. The information relating to a service requester may include a displayed name (e.g., a nickname), age, a gender, a telephone number, a brand of a telephone of the service requester, an occupation, a profile image, a documentation number (e.g., an identify card number, etc.), a third-party account (e.g., an email account), habits/preferences, locations that are often accessed by the service requester (e.g., a hotel, a guesthouse, a bar, a KTV club, etc.), the count of orders placed and subsequently cancelled by the service requester of all time or within a specific period of time (e.g., the past week(s), the past month(s), the past year(s), etc.), a count and/or frequency of complaints submitted by the service requester or being complained of submitted by service providers of all time or within a specific period of time (e.g., the past week(s), the past month(s), the past year(s), etc.), a criminal record, features extracted from the information posted on forums, blogs, or social networks by the service requester or relating to the service requester, or the like, or any combination thereof. The candidate provider features may include a displayed name (e.g., a nickname), age, a gender, a telephone number, a brand of a telephone of the service provider, an occupation, an e-mail address, a profile image, a documentation number (e.g., a driver's license number, an identity card number, etc.), a third-party account (e.g., an email account), a vehicle type, a vehicle age, a license plate, a certification status in the artificial intelligent system 100, driving experience, an endorsement, habits/preferences, locations that are often accessed by the service provider (e.g., a hotel, a guesthouse, a bar, a KTV club, etc.), the count of orders accepted and subsequently cancelled by the service provider of all time or within a specific period of time (e.g., the past week(s), the past month(s), the past year(s), etc.), a count and/or frequency of complaints submitted by the service provider or being complained of submitted by service requesters, a criminal record, a rating, features extracted from the information posted on forums, blogs, or social networks by the service provider or relating to the service provider, or the like, or any combination thereof.

In some embodiments, the dimension of the candidate features may be huge, and only part of the candidate features are highly correlated with the prediction of the target incident occurrence probability. The processing device 112 may select the features highly related to the prediction of the target incident occurrence probability to train the prediction model. Through feature selection, the prediction model may be simplified and accurate, the training time may be shorter, and the over fitting of the prediction model may be reduced.

Therefore, in 630, the processing device 112 (e.g., the feature selection sub-unit 414-3) may determine one or more target features from the plurality of candidate features using a feature selection algorithm. The feature selection algorithm may include a forward feature selection, a backward feature elimination, a recursive feature elimination, etc. The feature selection sub-unit 414-3 may determine a precision rate, a recall rate, and/or an accuracy rate of the prediction model through adding a feature or removing a feature using the feature selection algorithm to determine the target features. The target features may include one or more target order features, one or more target requester features, and/or one or more target provider features.

In 640, the processing device 112 (e.g., the model determination sub-unit 414) may generate the prediction model based on the one or more target features of the plurality of positive samples, the one or more target features of the plurality of negative samples, and/or the historical incident data of the plurality of positive samples and the plurality of negative samples. For example, the model determination sub-unit 414-4 may generate, based on a prediction model (also referred to herein as an initial prediction model), prediction results based on the one or more target features of positive samples and the one or more target features of the plurality of negative samples; then the model determination sub-unit 414-4 may determine the value of a loss function based on the prediction results with the historical incident data of plurality of positive samples and the plurality of negative samples. Then the model determination sub-unit 414-4 may determine whether a prediction model is satisfactory based on a criterion relating to a loss function. In some embodiments, when the value of the loss function is smaller than the predetermined threshold, the model determination sub-unit 414-4 may designate the initial prediction model as the prediction model, i.e., the prediction model has been trained well and is satisfactory. When the value of the loss function exceeds the predetermined threshold, the model determination sub-unit 414-4 may modify the initial prediction model and use the training data or obtain different training data to generate an updated prediction model until the updated prediction model satisfies the criterion.

It should be noted that the above description about the process 600 for determining the prediction model is merely an example, and not intended to be limiting. In some embodiments, the process 600 may be accomplished with one or more additional operations not described, and/or without one or more of the operations discussed. For example, after obtaining the training data in 610, the processing device 112 may preprocess the training data, e.g., remove abnormal data, make up or remove incomplete data. As another example, the processing device 112 may also obtain test data independent of the training data to access the performance of the prediction model. As still another example, the processing device 112 may perform cross-validation (e.g., k-fold cross validation) for training the prediction model.

In some embodiments, the training data may include data relating to more than one type of incident. The process 600 may also include dividing the training data into more than one group. Each group may correspond to an incident type. For each group, the processing device 112 may determine a sub-model to predict an occurrence probability of the corresponding incident. Then the processing device 112 may designate the more than one sub-model as the prediction model. When the processing device 112 uses the prediction model, the processing device 112 may generate an occurrence probability for each of the incident types. For example, the processing device 112 may determine that an occurrence probability of killing is 30, an occurrence probability of sexual harassment is 45, and an occurrence probability of robbery is 17.

In some embodiments, the processing device 112 may also determine the prediction model by assigning different weights to the more than one sub-model. When the processing device 112 uses the prediction model, the processing device 112 may determine an overall prediction about different incident types. For example, the processing device 112 may determine that an occurrence probability of a vicious incident is 40 based on occurrence probabilities of one or more types of incidents.

In some embodiments, the processing device 112 may train the prediction model offline. For example, the processing device 112 may generate the predication model in advance using training data and store the prediction model in a storage device (e.g., the storage device 150, the ROM 230, the RAM 240) of the artificial intelligent system 100 for future use. For instance, the processing device 112 may generate the predication model during an off-peak time when traffic to at least a portion of the artificial intelligent system 100 (e.g., the service requesting system, the service providing system, the server 110, or the like, or a combination thereof) is low (e.g., below a threshold). In some embodiments, the processing device 112 may generate the predication model not in response to but independent of individual real-time requests for service in the form of real-time orders or reservations. When the processing device 112 determines an occurrence probability of a target incident when a service provider serves a service requester, the processing device 112 may directly obtain the prediction model from the storage device (e.g., the storage device 150, the ROM 230, the RAM 240) of the artificial intelligent system 100. The processing device 112 may regularly or irregularly update the prediction model. In some embodiments, the processing device 112 may store the updated prediction model in a storage device (e.g., the storage device 150, the ROM 230, the RAM 240) of the artificial intelligent system 100.

In some embodiments, the training data may have an imbalanced composition. For instance, the training data may include many more positive samples than negative samples (i.e., the training data is imbalanced), and the performance (e.g., the predictive accuracy) of a model may be poor if the training data is imbalanced. Therefore, in some embodiments, it is desirable to use balanced training data (also referred to as balanced samples) to train the prediction model.

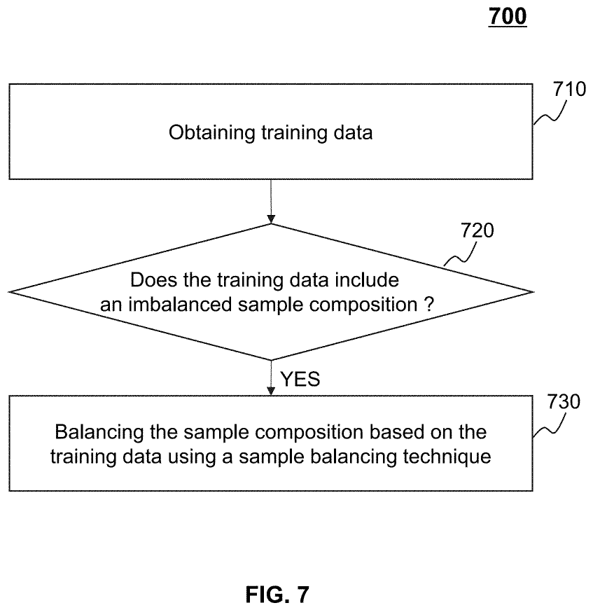

FIG. 7 is a flowchart illustrating an exemplary process for generating balanced samples according to some embodiments of the present disclosure. In some embodiments, the process 700 may be implemented in the artificial intelligent system 100 as illustrated in FIG. 1. For example, the process 700 may be stored in the storage device 150 and/or other storage device (e.g., the ROM 230, the RAM 240) as a form of instructions, and invoked and/or executed by the server 110 (e.g., the processing device 112 in the server 110, the processor 220 of the processing device 112 in the server 110, the one or more modules of the processing device 112 in the server 110).

In 710, the processing device 112 (e.g., the training data obtaining sub-unit 414-1) may obtain the training data. The training data may include a plurality of positive samples and a plurality of negative samples.

In 720, the processing device 112 (e.g., the sample balancing sub-unit 414-5) may determine whether the training data includes an imbalanced sample composition. For example, the sample balancing sub-unit 414-5 may obtain a count of positive samples, Mₚ, and a count of negative samples, Mₙ. The sample balancing sub-unit 414-5 may generate a ratio (also referred to herein as a sample ratio) between the count of majority samples and the count of minority samples. As used herein, between the positive samples and the negative samples in the training data, the type of samples with a higher sample count may be referred to as the majority samples, and the type of samples with a lower sample count may be referred to as the minority samples. For example, when the sample count of the positive samples is higher than the sample count of the negative samples of the training data, i.e. there are more positive samples than the negative samples in the training data, the positive samples are referred to as the majority samples and the negative samples are referred to as minority samples. As another example, when the sample count of the positive samples is lower than the sample count of the negative samples of the training data, i.e. there are fewer positive samples than the negative samples in the training data, the positive samples are referred to as the minority samples and the negative samples are referred to as majority samples. When the sample count of positive sample is larger than the sample count of the negative samples (i.e., the positive samples are majority samples and the negative samples are minority samples), the sample ratio may refer to Mₚ/Mₙ; when the sample count of negative sample is larger than the sample count of the positive samples (i.e., the positive samples are minority samples and the negative samples are majority samples), the sample ratio may refer to Mₙ/Mₚ. The sample balancing sub-unit 414-5 may determine whether the sample ratio exceeds a ratio threshold. The ratio threshold may be larger than or equal to 10. For example, the ratio threshold may be from 10 to 20, from 21 to 30, from 31 to 40, or larger than 40.

When the sample balancing sub-unit 414-5 determine that the sample ratio exceeds the ratio threshold, the sample balancing sub-unit 414-5 may determine that the training data includes an imbalanced sample composition, then the sample balancing sub-unit 414-5 may balance the sample composition based on the training data using a sample balancing technique in 730. In some embodiments, the sample balancing technique may include assigning different weights to the positive samples and negative samples. In some embodiments, the sample balancing technique may include re-sampling the training data, for example, over-sampling minority samples and/or under-sampling majority samples. In some embodiments, the positive samples in which the target incident has not occurred are majority samples and the negative samples in which the target incident has occurred are minority samples. Then the sample balancing sub-unit 414-5 may over-sampling the negative samples and/or under-sampling the positive samples.

In some embodiments, the sample balancing sub-unit 414-5 may under-sample the positive samples based on an under-sampling rate. The under-sampling rate may be determined based on the sample ratio. For example, when the count of the negative samples is larger than a predetermined number, the under-sampling rate may be a value approximately equal to the sample ratio. Assuming that the predetermined number is 1000, the count of the negative samples is 1200, the count of the positive samples is 1200000 (i.e., the sample ratio is 1000), then the sample balancing sub-unit 414-5 may under-sample the positive samples by randomly selecting one from, e.g., every 1000 positive samples.

In some embodiments, the sample balancing sub-unit 414-5 may over-sample negative samples. In some embodiments, negative samples may be oversampled by way of, e.g., copying all or part of the negative samples. In some embodiments, negative samples may be oversampled by way of, e.g., generating a plurality of synthetic samples using, e.g., a K nearest neighbors (KNN) technique and designating at least a portion of the plurality of synthetic samples as negative samples.

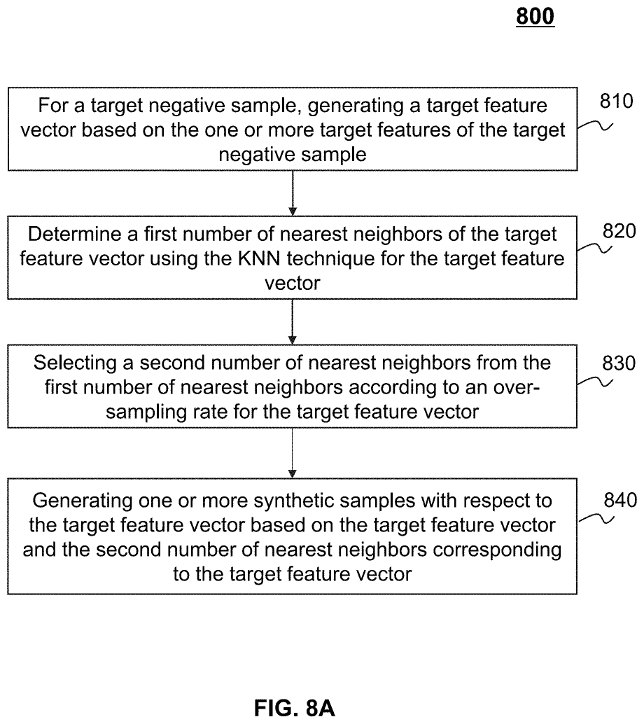

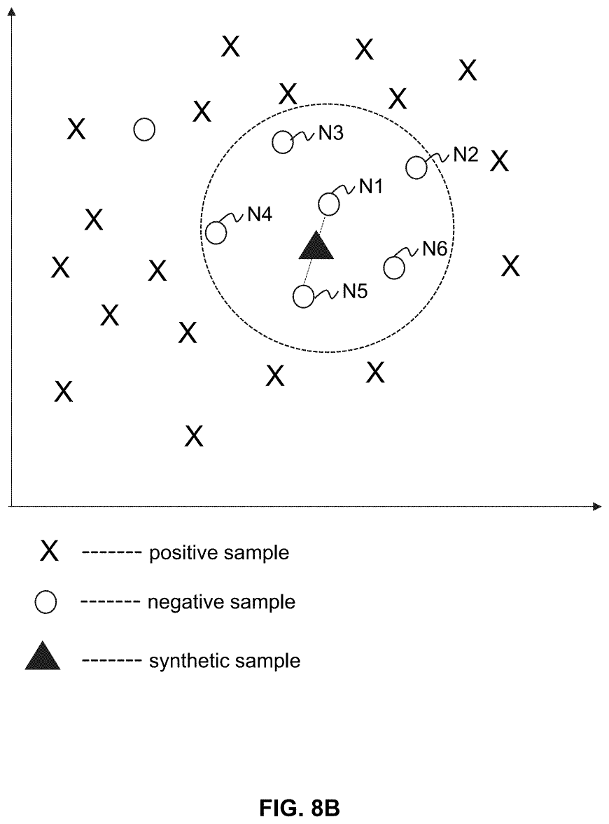

In the present disclosure, the training data may be in a data space. The data space may refer to a space in which a point may represent a sample (e.g., a positive sample, a negative sample). In some embodiments, the processing device 112 may generate synthetic samples in a feature space. The feature space may refer to a space in which a point may represent a feature vector. The dimension of the feature vector may be an arbitrary value, e.g., 10, 20, 30, 40, etc. FIG. 8B is a schematic diagram illustrating imbalanced samples. As shown in FIG. 8B, the cross signs correspond to positive samples or feature vectors corresponding to positive samples, open circles correspond to negative samples or feature vectors corresponding to negative samples.

FIG. 8A is a flowchart illustrating an exemplary process for generating synthetic samples using the KNN technique in the feature space according to some embodiments of the present disclosure. In some embodiments, the process 800 may be implemented in the artificial intelligent system 100 as illustrated in FIG. 1. For example, the process 800 may be stored in the storage device 150 and/or other storage device (e.g., the ROM 230, the RAM 240) as a form of instructions, and invoked and/or executed by the server 110 (e.g., the processing device 112 in the server 110, the processor 220 of the processing device 112 in the server 110, the one or more modules of the processing device 112 in the server 110).

In 810, the processing device 112 (e.g., the sample balancing sub-unit 414-5) may generate a target feature vector based on one or more target features of a negative sample (also referred to herein as a target negative sample). The dimension of the target feature vector may be the same as the count of the target features of the negative sample.

In some embodiments, the processing device 112 may also normalize the features in the feature vectors corresponding to the negative samples in the training data and/or the feature vectors corresponding to the positive samples in the training data. Then the processing device 112 may determine a distance (e.g., a Euclidean distance, a Minkowski distance, etc.) between any two feature vectors using normalized features.

In 820, the processing device 112 (e.g., the sample balancing sub-unit 414-5) may determine a first number of nearest neighbors of the feature vector using the KNN technique for the target feature vector based on the distance between each of the feature vectors corresponding to the negative samples in the training data and the target feature vector. The first number may be any suitable value, e.g., 5, 6, 7, etc.

In some embodiments, the sample balancing sub-unit 414-5 may determine the first number of nearest neighbors from both feature vectors corresponding to negative samples near the target negative sample and feature vectors corresponding to positive samples near the target negative sample. In some embodiments, the sample balancing sub-unit 414-5 may determine the first number of nearest neighbors only from feature vectors corresponding to negative samples. As shown in FIG. 8B, the first number is five, and for the feature vector (N1) of a negative sample (also referred to herein as the target feature vector), the sample balancing sub-unit 414-5 may determine five nearest neighbors N1, N3, N4, N5, and N6 and all of the five nearest neighbors are feature vectors corresponding to five negative samples.

In 830, for the target feature vector, the processing device 112 (e.g., the sample balancing sub-unit 414-5) may determine a second number of nearest neighbors from the first number of nearest neighbors determined in 820. In some embodiments, the second number may be a predetermined number, e.g., one, two, three, etc. In some embodiments, the second number may be determined based on an over-sampling rate, e.g., the second number may be an integer nearest to the over-sampling rate. For example, if the count of negative samples is 100 and a target count of negative samples is 200 (i.e., the over-sampling rate is 200%), then the sample balancing sub-unit 414-5 may determine the second number to be two.

In some embodiments, the sampling balancing sub-unit 414-5 may randomly select the second number of nearest neighbors from the first number of nearest neighbors. In some embodiments, the sample balancing sub-unit 414-5 may select the second number of nearest neighbors based on the distance between each of the first number of nearest neighbors and the target feature vector. For example, the sample balancing sub-unit 414-5 may select the second number of nearest neighbor based on the distance between each of the first number of nearest neighbors (e.g., N1, N3, N4, N5, N6) and the target feature vector (e.g., N1) and then select the second number of nearest neighbors corresponding to one or more smallest distances from the first number of nearest neighbors (e.g., N1, N3, N4, N5, N6). The distance between two feature vectors may indicate a degree of similarity between the two feature vectors.

In 840, for the target feature vector, the processing device 112 (e.g., the sample balancing sub-unit 414-5) may generate one or more synthetic feature vectors with respect to the target feature vector based on the target feature vector and the second number of nearest neighbors corresponding to the target feature vector.

In some embodiments, for each of the second number of nearest neighbors of the target feature vector, the sample balancing sub-unit 414-5 may determine a difference between the nearest neighbor (e.g., feature vector N5) and the target feature vector (e.g., feature vector N1). Then the sample balancing sub-unit 414-5 may multiply the difference by a coefficient between 0 and 1 to determine a synthetic feature vector. A sample corresponding to a synthetic feature vector may be referred to herein as a synthetic sample. As shown in FIG. 8B, the difference may be represented as a line segment between N5 and N1, and the synthetic feature vector may be represented as a point (shown as a solid triangle) in the line segment. It should be noted that the symbol solid triangle may represent a synthetic sample in the data space or a synthetic feature vector in the feature space.

In some embodiments, the sample balancing sub-unit 414-5 may determine two or more synthetic feature vectors in a line segment connecting two specific feature vectors corresponding to two specific samples (e.g., two negative samples, or one positive sample and the target negative sample). For example, the sample balancing sub-unit 414-5 may multiply the difference of the two specific feature vectors by two or more coefficients between 0 and 1 to determine two or more synthetic feature vectors. For example, for the line segment connecting N5 and N1, the sample balancing sub-unit 414-5 may select two or more points in the line segment corresponding to two or more synthetic feature vectors. In some embodiments, a coefficient may be selected randomly between 0 and 1. In some embodiments, if multiple coefficients are used to determine multiple synthetic feature vectors in a line segment connecting two specific feature vectors corresponding to two specific samples, the coefficients may be equally spaced from each other or not. For instance, two coefficients are used to determined two synthetic feature vectors in a line segment connecting two specific feature vectors corresponding to two negative samples, the coefficients may be ⅓ and ⅔, or ⅓ and ¼, etc.

It should be noted that the above description about the process for generating synthetic samples for a target negative sample using the KNN technique is merely an example, and not intended to be limiting. In some embodiments, the sample balancing sub-unit 414-5 may use other technique to generate one or more synthetic samples for the target negative sample. For example, the sample balancing sub-unit 414-5 may determine a region (e.g., a circular region with a radius centered at the target feature vector). The radius may be fixed or adjustable according to one or more of various factors including, e.g., the count of negative samples in the training data, the count of positive samples in the training data, the sample ratio relating to the training data, etc. In some embodiments, for different target feature vectors, the radiuses may be different. Samples in the region may include negative samples, positive samples, or both. Then the sample balancing sub-unit 414-5 may determine synthetic samples based on the samples (e.g., only the negative samples, or both the negative samples and the positive samples) in the region.

In some embodiments, to determine a synthetic sample based on the target sample, the sample balancing sub-unit 414-5 may directly select a certain number (e.g., the second number) of nearest neighbors of the target feature vector based on a distance between a feature vector corresponding to a sample (e.g., a negative sample, a positive sample) in the training data (e.g., one in a vicinity of the target feature vector of the target sample) and the target feature vector corresponding to the target sample without performing operation 820.

FIG. 8A shows a process 800 for determine synthetic samples for a target negative sample. To generate a balance sample composition, the processing device 112 may perform the process 800 for each of at least some of the negative samples in the training data.

When the synthetic samples corresponding to the synthetic feature vectors corresponding to all the feature vectors of the at least some of the negative samples in the training data are generated, the sample balancing sub-unit 414-5 may designate samples corresponding to the synthetic feature vectors as negative samples so that the sample composition is balanced. Then the processing device 112 may train the prediction model using the balanced samples. In some embodiments, the synthetic feature vector of a synthetic sample may be generated based only on feature vectors of actual samples in the original training data, but not on the synthetic feature vector of another synthetic sample.

FIG. 9 is a flowchart illustrating an exemplary process for allocating orders according to some embodiments of the present disclosure. In some embodiments, the process 900 may be implemented in the artificial intelligent system 100 as illustrated in FIG. 1. For example, the process 900 may be stored in the storage device 150 and/or other storage device (e.g., the ROM 230, the RAM 240) as a form of instructions, and invoked and/or executed by the server 110 (e.g., the processing device 112 in the server 110, the processor 220 of the processing device 112 in the server 110, the one or more modules of the processing device 112 in the server 110).

In 910, the processing device 112 (e.g., the order information obtaining unit 421) may obtain one or more target orders to be allocated from one or more service requester terminals. The one or more service requester terminals may be associated with one or more service requesters. The information relating to each of the target orders may include a starting location of the target order, the destination of the target order, a route from the starting location to the destination of the target order, neighborhood along the route of the target order, a starting time of the target order, an estimated time of arrival of the target order, a type of the target order, a service type relating to the target order, or the like, or any combination thereof. The type of the target order may include a real-time order or a reservation of a service for a future time. The service type may include a taxi service, an express service, a car service with a special accommodation (e.g., wheelchair accessible, car seat equipped, a certain occupancy capacity, etc.), or the like, or any combination thereof. The requester information obtaining unit 422 may also obtain information relating to the service requesters associated with the one or more target orders. For example, the requester information obtaining unit 422 may also obtain the information relating to the service requesters from the storage device 150 or other storage device in the server 110 or external storage device of the artificial intelligent system 100. The information relating to the service requester may include a displayed name (e.g., a nickname), age, a gender, a telephone number, a brand of a telephone of the service requester, an occupation, a profile image, a documentation number (e.g., an identify card number, etc.), a third-party account (e.g., an email account), habits/preferences, locations that are often accessed by the service requester (e.g., a hotel, a guesthouse, a bar, a KTV club, etc.), the count of orders placed and subsequently cancelled by the service requester of all time or within a specific period of time (e.g., the past week(s), the past month(s), the past year(s), etc.), a count and/or frequency of complaints submitted by the service requester or being complained of submitted by service providers of all time or within a specific period of time (e.g., the past week(s), the past month(s), the past year(s), etc.), a criminal record, information posted on forums, blogs, or social networks by the service requester or relating to the service requester, or the like, or any combination thereof.

In some embodiments, one or more requester terminals 130 of the service requesting system may send and/or transmit electronic signals including the one or more target orders to the server 110 via at least one first information exchange port. The one or more requester terminals 130 may exchange information with the server 110 through wireless communication. The service requesting system may include the one or more requester terminals 130 and the network 120. The at least one first information exchange port may facilitate a communication between each of the one or more requester terminals 130 and the server 110 via the network 120. For example, the at least one first information exchange port may be one or more network I/O ports (e.g., antennas) connected to and/or in communication with the server 110. The at least one first information exchange port corresponding to or in communication with the service requesting system may transmit the electronic signals including the one or more target orders to the processing device 112.

In 920, the processing device 112 (e.g., the provider information obtaining unit 423) may identify a plurality of candidate service providers available to accept the one or more target orders. In some embodiment, the processing device 112 may obtain locations of a plurality of service providers through positioning modules of provider terminals in real time. Then the processing device may identify the candidate service providers that are available to accept orders and that are within a predetermined range (e.g., 2 kilometers) around the starting location of each of the target orders. The provider information obtaining unit 423 may also obtain information relating to the plurality of candidate service providers. For example, the provider information obtaining unit 423 may also obtain the information relating to the plurality of candidate service providers from the storage device 150 or other storage device in the server 110 or external to the artificial intelligent system 100. The information relating to each of the plurality of candidate service providers may include a displayed name (e.g., a nickname), age, a gender, a telephone number, a brand of a telephone of the candidate service provider, an occupation, an e-mail address, a profile image, a documentation number (e.g., a driver's license number, an identity card number, etc.), a third-party account (e.g., an email account), a vehicle type, a vehicle age, a license plate, a certification status in the artificial intelligent system 100, driving experience, an endorsement, habits/preferences, locations that are often accessed by the candidate service provider (e.g., a hotel, a guesthouses, a bar, a KTV club, etc.), the count of orders accepted and subsequently cancelled by the candidate service provider of all time or within a specific period of time (e.g., the past week(s), the past month(s), the past year(s), etc.), a count and/or frequency of complaints submitted by the candidate service provider or being complained of submitted by service requesters, a criminal record, a rating, information posted on forums, blogs, or social networks by the candidate service provider or relating to the candidate service provider, or the like, or any combination thereof.

When the order allocation module 420 obtains the information of the one or more orders, the information of the service requesters associated with the one or more target orders, and the information of the plurality of candidate service providers, the order allocation module 420 may send the information to the incident prediction module 410 to determine target incident occurrence probabilities.

In 930, the processing device 112 (e.g., the requester-provider pair determination unit 424) may determine candidate requester-provider pairs by associating each of the one or more target service requesters with each of the plurality of candidate service providers. The requester-provider pair determination unit may be part of the incident prediction module 410, the order allocation module 420, or other component of the processing device 112. For example, assuming that the count of the target orders to be allocated is M1 and the count of the candidate service provider is M2, the requester-provider pair determination unit may generate M1×M2 candidate requester-provider pairs.

In 940, the processing device 112 (e.g., the incident prediction module 410) may determine a target incident occurrence probability that a target incident occurs for each of the candidate requester-provider pairs. The target incident may include be a vicious incident, e.g., assault, sexual harassment, killing, drunkenness, rape, robbery, etc. Detailed descriptions about the determining of the target incident occurrence probability may be found elsewhere in the present disclosure. See, e.g., FIG. 5 and the relevant descriptions thereof.

When the target incident occurrence probabilities corresponding to all of the candidate requester-provider pairs have been determined, the order allocation module 420 may obtain target incident occurrence probabilities from the incident prediction module 410. Then in 950, the order allocation module 420 (e.g., the order allocation unit 425) may allocate the target orders based at least in part on the target incident occurrence probabilities and corresponding candidate requester-provider pairs. In some embodiments, the order allocation module 420 (e.g., the order allocation unit 425) may determine whether to allocate a target order to a service provider according to other factors including, e.g., a distance between a location of the service provider and a starting location of the target order, a length of time moving from the location of the service provider to the starting location of the target order, traffic information, provider features (e.g., the service type of the service provider, the vehicle type of the service provider, the service score of the service provider, etc.), the service provider's demands (e.g., the gender of a service requester, the destination(s) of orders that the service provider prefers or accepts, etc.), the service requester's demands (e.g., the gender of a service provider), etc. In some embodiments, the order allocation module 420 (e.g., the order allocation unit 425) may assign weights to the target incident occurrence probabilities and such other factors to decide how to allocate the target orders. In some embodiments, for a same target order, the weights assigned to the target incident occurrence probability and one or more of such other factors may be the same or different. In some embodiments, the weight assigned to the target incident occurrence probability associated with the target order may be larger than the weights assigned to one or more of such other factors. In some embodiments, for different target orders, the weights assigned to the target incident occurrence probabilities associated with the target orders may be the same or different.

In some embodiments, the processing device 112 may send and/or transmit second electronic signals including the information of the allocated target orders to one or more provider terminals associated with the plurality of service providers via the at least one second information exchange port corresponding to the service providing system. The one or more provider terminals 140 may exchange information with the server 110 through wireless communication. The service providing system may include one or more provider terminals 140 and the network 120. The at least one second information exchange port may facilitate a communication between the one or more provider terminals 140 and the server 110. For example, the at least one second information exchange port may be one or more network I/O ports (e.g., antennas) connected to and/or in communication with the server 110.

Therefore, when the processing device 112 allocates orders, taking the target incident occurrence probability into consideration may make the allocation more reasonable and reduce the possibility of a target incident (e.g., a vicious incident), which may be helpful to protect the personal safety and/or property safety of the service providers and/or the service requesters and maintain social stability.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A non-transitory computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A system of one or more electronic devices for determining a target incident occurrence probability, comprising:
at least one storage device including an operation system and a first set of instructions compatible with the operation system for determining an occurrence probability of a target incident; and
at least one processor in communication with the at least one storage device, wherein when executing the operation system and the first set of instructions, the at least one processor is directed to:
extract target order features of an order associated with a service requester;
extract target requester features of the service requester;
extract target provider features of a service provider;
obtain a prediction model for determining a probability that the target incident occurs; and
determine the occurrence probability of the target incident using the prediction model based on the target order features, the target requester features, and the target provider features.

2. The system of claim 1, wherein to obtain the prediction model, the at least one processor is further directed to:
obtain training data, the training data including a plurality of positive samples in each of which the target incident has not occurred and a plurality of negative samples in each of which the target incident has occurred, each of the plurality of positive samples and the plurality of negative samples including historical transaction data and historical incident data corresponding to the historical transaction data;
extract a plurality of candidate features from the historical transaction data of the plurality of positive samples and the plurality of negative samples;
for each of the plurality of positive samples and the plurality of negative samples, determine one or more target features from the plurality of candidate features using a feature selection algorithm; and
generate the prediction model based on the one or more target features of the plurality of positive samples, the one or more target features of the plurality of negative samples, and the historical incident data of the plurality of positive samples and the plurality of negative samples.

3. The system of claim 2, wherein to obtain the prediction model, the at least one processor is further directed to:
determine that the training data includes an imbalanced sample composition based on the plurality of positive samples and the plurality of negative samples; and
in response to a determination that the training data includes an imbalanced sample composition, balance the sample composition based on the training data using a sample balancing technique.

4. The system of claim 3, wherein the sample balancing technique includes under-sampling the plurality of positive samples.

5. The system of claim 3, wherein the sample balancing technique includes over-sampling the plurality of negative samples.

6. The system of claim 5, wherein to balance the sample composition, the at least one processor is further directed to:
determine a plurality of synthetic samples using a K nearest neighbors (KNN) technique; and
designate the plurality of synthetic samples as negative samples.

7. The system of claim 6, wherein to determine the plurality of synthetic samples using the KNN technique, the at least one processor is directed to:
for each of the plurality of negative samples, generate a feature vector based on the one or more target features of the negative sample; and
for each of the feature vectors, determine a first number of nearest neighbors of the feature vector using the KNN technique;
select a second number of nearest neighbors from the first number of nearest neighbors according to an over-sampling rate; and
generate synthetic samples with respect to the feature vector based on the feature vector and the second number of nearest neighbors.

8. The system of claim 1, wherein the at least one storage device further includes a second set of instructions compatible with the operation system for allocating orders, and wherein when the at least one processor executes the second set of instructions, the at least one processor is further directed to:
obtain one or more target orders from one or more requester terminals associated with one or more target service requesters;
identify a plurality of candidate service providers available to accept the one or more target orders;
determine candidate requester-provider pairs by associating each of the one or more target service requesters with each of the plurality of candidate service providers;
for each of the candidate requester-provider pairs, execute the first set of instructions to determine an occurrence probability that the target incident occurs; and
allocate the one or more target orders based at least in part on the occurrence probabilities of the target incident and corresponding candidate requester-provider pairs.

9. The system of claim 1, wherein the prediction model is an eXtreme Gradient Boosting (Xgboost) model.

10. The system of claim 1, wherein the target incident includes at least one of: assault, sexual harassment, killing, drunkenness, rape, or robbery.

11. A method for determining an occurrence probability of a target incident, implemented on one or more electronic devices having at least one storage device, and at least one processor in communication with the at least one storage device, comprising:
extracting target order features of an order associated with a service requester;
extracting target requester features of the service requester;
extracting target provider features of a service provider;
obtaining a prediction model for determining a probability that the target incident occurs; and
determining the occurrence probability of the target incident using the prediction model based on the target order features, the target requester features, and the target provider features.

12. The method of claim 11, wherein the obtaining the prediction model comprises:
obtaining training data, the training data including a plurality of positive samples in each of which the target incident has not occurred and a plurality of negative samples in each of which the target incident has occurred, each of the plurality of positive samples and the plurality of negative samples including historical transaction data and historical incident data corresponding to the historical transaction data;
extracting a plurality of candidate features from the historical transaction data of the plurality of positive samples and the plurality of negative samples;
for each of the plurality of positive samples and the plurality of negative samples, determining one or more target features from the plurality of candidate features using a feature selection algorithm; and
generating the prediction model based on the one or more target features of the plurality of positive samples, the one or more target features of the plurality of negative samples, and the historical incident data of the plurality of positive samples and the plurality of negative samples.

13. The method of claim 12, wherein the obtaining the prediction model further comprises:
determining that the training data includes an imbalanced sample composition based on the plurality of positive samples and the plurality of negative samples; and
in response to a determination that the training data includes an imbalanced sample composition, balancing the sample composition based on the training data using a sample balancing technique.

14. The method of claim 13, wherein the sample balancing technique includes under-sampling the plurality of positive samples.

15. The method of claim 13, wherein the sample balancing technique includes over-sampling the plurality of negative samples.

16. The method of claim 15, wherein the balancing the sample composition further comprises:
determining a plurality of synthetic samples using a K nearest neighbors (KNN) technique; and
designating the plurality of synthetic samples as negative samples.

17. The method of claim 16, wherein the determining the plurality of synthetic samples using the KNN technique comprises:
for each of the plurality of negative samples, generating a feature vector based on the one or more target features of the negative sample; and
for each of the feature vectors,
determining a first number of nearest neighbors of the feature vector using the KNN technique;
selecting a second number of nearest neighbors from the first number of nearest neighbors according to an over-sampling rate; and
generating synthetic samples with respect to the feature vector based on the feature vector and the second number of nearest neighbors.

18. The method of claim 11, further comprising:
obtaining one or more target orders from one or more requester terminals associated with one or more target service requesters;
identifying a plurality of candidate service providers available to accept the one or more target orders;
determining candidate requester-provider pairs by associating each of the one or more target service requesters with each of the plurality of candidate service providers;
for each of the candidate requester-provider pairs, determining an occurrence probability that the target incident occurs; and
allocating the one or more target orders based at least in part on the occurrence probabilities of the target incident and corresponding candidate requester-provider pairs.

19. (canceled)

20. The method of claim 11, wherein the target incident includes at least one of: assault, sexual harassment, killing, drunkenness, rape, or robbery.

21. A non-transitory computer readable medium, comprising an operation system and at least one set of instructions compatible with the operation system for determining an occurrence probability of a target incident, wherein when executed by at least one processor of one or more electronic device, the at least one set of instructions directs the at least one processor to:
extract target order features of an order associated with a service requester;
extract target requester features of the service requester;
extract target provider features of a service provider;
obtain a prediction model for determining a probability that the target incident occurs; and
determine the occurrence probability of the target incident using the prediction model based on the target order features, the target requester features, and the target provider features.

22-44. (canceled)
